(19) United States
(12) Patent Application Publication
(10) Pub. No.: US 2003/0233219 A1
(43) Pub. Date: Dec. 18, 2003

(54) Method and apparatus emulating read only memories with combinatorial logic networks, and methods and apparatus generating read only memory emulator combinatorial logic networks

(76) Inventors: Geroge Landers, Mountain View, CA (US); Earle Willis Jennings III, Kensington, CA (US)

Correspondence Address: EARLE JENNINGS, 8 KENYON AVE, KENSINGTON, CA, 94708, US

(21) Appl. No.: 10/155,502

(22) Filed: May 23, 2002

(51) Int. Cl. G06F 17/50

(52) U.S. Cl. 703/14

(57) ABSTRACT

The invention includes combinatorial logic networks emulating ROMs (RECLNs) and an emulation method for ROMs, as well as emulating synchronous ROMs with RECLN's coupled to synchronizing interfaces. The invention includes methods and apparatus generating synthesizable RECLN descriptions, as well as, circuit descriptions, netlists, circuit layouts, mask sets, unpackaged integrated circuit wafers, integrated circuits, and systems products using the synthesizable RECLN descriptions and products derived therefrom. The invention also includes method and apparatus for doing business involving generation of synthesizable RECLN descriptions and/or the above mentioned derived products. The invention also includes creating installation mechanisms for synthesizable RECLN generation methods to create systems generating synthesizable RECLN descriptions.

### TECHNICAL FIELD

This invention relates to Read-Only-Memories (ROMs) as found in integrated circuits and systems products.

### BACKGROUND OF INVENTION

Since at least the 1970's Random Access Memories (RAMs) made of semiconductor devices have provided enormous benefit to the technology and economy of the world. Most RAMs have the property that they can be written as well as read while in normal operation. Read Only Memories (ROMs) are a form of Random Access Memory not able to be written during normal operation. This invention concerns a fundamental circuit improvement emulating the performance of a ROM based upon its ROM pattern as well as its operation. The invention also includes methods and apparatus generating these circuits and defining their operation.

FIG. 1A illustrates the structure of prior art Random Access Memories in general, and ROMs in particular.

To the inventors' knowledge, all semiconductor memories physically operate two dimensional arrays of memory cells denoted by “Mj,k” in FIG. 1A, where j varies from 0 to 3 and k from 1 to 6. Each memory cell contains a bit of data.

Accessing the contents of a semiconductor memory is usually called reading the memory. This is the primary and often only function of a ROM. ROMs are typically operated as follows: a collection of address bits denoted as A1-A10 are presented to a row decoder circuit, generating a collection of row decode signals R0-3, each row decode signal Rj enables a row of the memory cell array Mj,1-6 to affect the condition of a collection of column signals C1-6. The column signals C1-6 are presented to a column decoder, which translates their signal conditions into digital signals D1-6.

The row decoder circuit often includes a collection of two input combiners, each generating four signals. Address bits A1,2 generate, through their two input combiner, the signals P0-3. Address bits A3,4 generate, through their two input combiner, the signals P4-7, and so on. Typically, P0=not A1 and not A2, P1=A2 and not A2, P2=not A1 and A2, and P3=A1 and A2, where not as well as and are logic operators. Exactly one of the four P signals will ever be turned on at a time. By selecting one of these four signals from each group of four P signals, and performing a logical operation anding the selected signals together, the row select signals R are formed. Often the logical complement of the and operator, known as nand is used to generate the row select signals R.

FIG. 1B illustrates a typical use of a prior art ROM circuit 100 by an engine 110 providing address signals A[1-N] and receiving data D[1-M].

The inventors have great respect for this workhorse of the computing and electronics industry. ROMs have played a central role in starting up almost all circuits controlled by or using computers. By way of example, ROMs are found in nearly every computer, modem, disk drive, printer, fax machine, set-top box, DVD player and cellular telephone manufactured today or in the last forty years.

While memories in general, and ROMs in particular, are the pervasive solution to the providing data for instructions and constants, they possess some significant problems, which will be discussed first from the standpoints of the semiconductor manufacturers, then from integrated circuit (IC) design, IC manufacturing, and lastly IC users.

The research and development cost paid by semiconductor manufacturers for new manufacturing processes is truly staggering. Each semiconductor manufacturer typically spends billions of US dollars to find and implement even an incremental improvement in manufacturing, such as going from a 0.25 micron CMOS process to a 0.18 micron CMOS process. For fundamental process technology innovations, such as the contemporary work to implement photonic and/or molecular switches, possibly employing micron length optical signal channels and/or nanotube signal tunnels, the cost is far greater.

Once a manufacturing process has been implemented in a factory, there is a large amount of design collateral which must be put in place before a single computer can be manufactured with that factory. Computers minimally require at least a few gate layouts and ROM's. ROM generation software is needed to take the specific memory data and generate a layout of ROM to be used in integrated circuits. The development and qualification of ROM cells and ROM generation software is thus in the critical path to make the first computers for the new process technology. This is a significant cost, and often a source of delay, for the start of production in many semiconductor factories. What is needed by the semiconductor manufacturers is a way to achieve the function of ROMs without requiring the development and qualification expenses of ROMs and ROM layout generators.

Semiconductor (IC) product design, particularly for embedded systems products, often requires at least one, and frequently several, ROMs. Each ROM requires a different layout, further requiring design expense to apply ROM layout generation for each ROM. The job of developing a specific IC product often has the generation and integration of ROM layouts in the critical path to generating the completed integrated circuit layout (known hereafter as circuit layout), which is the critical path predecessor to generating the lithography masks, known as the mask set of the integrated circuit. If an IC product is successful, there is often a need to convert the design to a different manufacturing process, which again, often requires new ROM layouts be generated, integrated to provide the circuit layout and subsequently, the mask set. What is needed by the IC product designer is a way to have the ROM functionality without incurring the delays and expenses associated with ROM layout generation every time a manufacturing process is targeted.

The IC manufacturing expenses to create unpackaged IC wafers are directly related to the size of the integrated circuit being made. While there are various rules of thumb regarding manufacturing cost, it is often at least proportional to the square of the surface area. Experiments by the inventors have shown in certain cases very significant reductions in the surface area of circuitry requiring ROMs. What is needed is a way to reduce the surface area of an IC requiring at least one ROM's functionality.

The prior art includes an extensive research and development concerning logic functions and operations as well as the implementation of these functions and operations as logic gates. Starting in the late 1940's, it became well recognized that switching mechanisms such as vacuum tubes, relays, semiconductor switches such as transistors and their descendants, and contemporary digital integrated circuits, could be described as networks of logical functions.

Logic functions act upon one or more logic inputs to generate a logic output. Logic inputs and outputs typically have logic values equivalent to a two element collection including ‘0’ and ‘1’. There are situations in which logic values belong to a larger set. Often these larger logic value sets are described in terms of ordered vectors whose elements are ‘0’ and ‘1’. These larger logic values are sometimes referred to as “multiple-valued” logic values.

Discussion of multiple-value logics would entail a lengthy digression, but briefly, functions and operations upon these logics can be defined in terms of logic functions and operations on 2 value logic terms. This leaves only the question of what are these logic operations and functions acting upon two valued terms. Note that this simplification of discussion is done strictly to render this document more readable, and not to either explicitly nor implicitly limit the scope of the claims. There are four classic functions which will be used extensively herein, and are defined in the following table.

| A | B | not A | A and B | A or B | A xor B |
|---|---|---|---|---|---|
| 0 | 0 | 1 | 0 | 0 | 0 |
| 0 | 1 | 1 | 0 | 1 | 1 |
| 1 | 0 | 0 | 0 | 1 | 1 |
| 1 | 1 | 0 | 1 | 1 | 0 |

Table One illustrates the classical logic functions and operations of negation, product, sum and exclusive or.

Two inputs, A and B take on all combinations of ‘0’ and ‘1’. Negation of A is denoted by the column not A. The product of the two terms is denoted as the column A and B. The logical sum of the two terms is denoted as the column A or B. The exclusive-or of the two terms is denoted as the column A xor B. Negation is often referred to as an unary operation acting upon one input.

Whereas the logical product, sum and exclusive-or operations are often referred to as binary operations acting upon two inputs. These binary operations have the very useful property in their indifference to the ordering of inputs (associativity and commutativity) which support a natural extension of these operations to acting upon more than two inputs. A or (B or C) is identical to (A or B) or C, to A or (C or B), and so on. This is the basis for subsequent references logical sums, products and exclusive-or's acting upon two or more inputs.

Three other commonly used logic functions-operations are defined in the next table.

| | | A nand B | A nor B | A xnor B |
|---|---|---|---|---|
| A | B | not (A and B) | not (A or B) | not (A xor B) |
| 0 | 0 | 1 | 1 | 1 |
| 0 | 1 | 1 | 0 | 0 |
| 1 | 0 | 1 | 0 | 0 |
| 1 | 1 | 0 | 0 | 1 |

Table Two illustrates Nand, Nor and exclusive-nor logic functions and operations.

The nand function is defined by the column ‘not (A and B)’. The nor function is defined by the column ‘not (A or B)’. The xnor function is defined by the column ‘not (A xor B)’.

As digital logic evolved, differing manufacturing processes favored implementations of different logic functions. By way of example, contemporary mosfet, in particular CMOS logic, manufacturing processes make very good implementations, known hereafter as gates, for nand functions of up to four or five inputs and can be used to implement reasonable two input nor and two input exclusive or gates. An earlier logic manufacturing process, using what were referred to as emitter-coupled-logic (ECL) transistors, did a very good job making gates implementing nor functions of up to twenty logical inputs, but did not do as well with nand gates and exclusive or gates.

A combinatorial logic network will refer to a network of combinations of simple gates connected together so that inputs of the network provide inputs to at least some of the simple gates, and their outputs flow toward the outputs of the network as a whole, possibly through acting as inputs to other gates in the network. Combinatorial logic networks do not possess “loops” causing the effects of a network output to “feed back” into the network.

In the early periods of digital manufacturing, the wiring of gates built out of relays, vacuum tubes, transistors and printed circuit boards holding modules of such components, was done by hand based upon a wiring list, which came to be known as a netlist. By the mid-1980's a netlist language standard known as ‘edif’ had gained industry acceptance. Generation of layouts of printed circuits and integrated circuits became largely automated tasks of ever increasing subtlety, culminating today in extremely sophisticated multiple wiring layer products at both the system product and integrated circuit level.

The 1980's also saw the development of circuit specification languages such as Verilog and VHDL, which support event driven simulators. Concurrently, the synthesis of logic functions into gates and customizable gate networks, known variously as Programmable Logic Arrays, Gate Arrays, and Field Programmable Gate Arrays reached a new level of automation. It widely became possible for someone to specify a logic function and define a combinatorial logic network that would perform that function. One well known example from this era is known as “espresso”, which was developed primarily at the Berkeley campus of the University of California and documented in a book entitled “Logic Minimization Algorithms for VLSI Synthesis” by Brayton, et. al., (c) 1984. The research of the time into synthesizing circuit descriptions also provided a second major result, circuit synthesis tools such as those developed by Synopsis, Cadence, and others which translate versions of event languages such as Verilog and VHDL into optimized networks of gates targeting specific manufacturing processes and gate layouts.

By the mid 1990's hand derivation of logic networks and their layout largely became obsolete. By the end of the twentieth century, committing an integrated circuit product design to production largely became a matter of synthesizing the product's logic, except for memories. ROM designs, in particular, require specialized layouts and their generation is always in the critical path to making a product's circuit layout and mask set. RAM layouts can often be pre-ordered, but until every bit of the ROM is committed, the ROM layouts cannot be generated.

To summarize, semiconductor manufacturers need a way to achieve the function of ROMs without requiring the development and qualification expenses of ROMs and ROM layout generators. IC product designers need a way to have the ROM functionality without incurring the delays and expenses associated with ROM layout generation every time a manufacturing process is targeted for an integrated circuit. What is further needed is a way to reduce the surface area of an IC requiring at least one ROM's functionality.

### SUMMARY OF INVENTION

The invention addresses at least all the above mentioned needs found in the prior art. Semiconductor manufacturers can provide the function of ROMs without the development and qualification expenses of ROMs and ROM layout generators. IC product designers gain ROM functionality without incurring the delays and expenses associated with ROM layout generation every time a manufacturing process is targeted for an integrated circuit. Often these new circuit layouts are smaller than the emulated ROM's layout, lowering unpackaged IC wafers costs, leading to integrated circuit and systems product cost reductions.

The invention includes combinatorial logic networks emulating a ROM known herein as ROM Emulator Combinatorial Logic Networks (RECLN). The RECLN receives at least two address input signals and generates at least one data output signal to emulate a ROM receiving the same address input signals and presenting essentially the same output data signals.

The invention includes an emulation method for the ROM, receiving the address input signals and generating the data output signal(s) by performing combinations of logical operations upon the received address input signals.

The invention includes methods and apparatus generating synthesizable RECLN descriptions, as well as, circuit descriptions, netlists, circuit layouts, mask sets, unpackaged integrated circuit wafers, integrated circuits, and systems products using the synthesizable RECLN descriptions and products derived therefrom. The invention also includes method and apparatus for doing business involving generation of synthesizable RECLN descriptions and/or the above mentioned derived products. The invention also includes creating installation mechanisms for synthesizable RECLN generation methods to create systems generating synthesizable RECLN descriptions.

### BRIEF DESCRIPTION OF DRAWINGS

FIG. 1A illustrates the structure of prior art Random Access Memories in general, and ROMs in particular;

FIG. 1B illustrates a typical use of a prior art ROM circuit 100 by an engine 110 providing address signals A[0-n] and receiving data D[0-m];

FIG. 1C illustrates an RECLN circuit 200 including at least an output generator collection including an output generator 230-k for each data output D[k] receiving 202-k at least some of the input signals A[0-n] and possibly receiving 224-k at least some shared signals 220 from 222-1 and/or 222-2 shared signal generator collection 220;

FIG. 1D illustrates using an RECLN circuit 200 replacing ROM circuit 100;

FIG. 1E illustrates a synchronous ROM emulator circuit including RECLN circuit 200 as part of a example of FIG. 1D;

FIG. 2A illustrates a flowchart of operation 1000 of a method generating a synthesizable RECLN description emulating a ROM;

FIG. 2B illustrates a detail flowchart of operation 1022 of FIG. 2A further converting the logic minimization into the synthesizable RECLN description;

FIG. 3A illustrates a detail flowchart of operation 1032 of FIG. 2A further receiving the ROM input communication;

FIG. 3C illustrates a detail flowchart of method 1000 of FIG. 2A further generating the synthesizable RECLN description;

FIG. 3B illustrates a detail flowchart of method 1000 of FIG. 2A further generating the synthesizable RECLN description;

FIG. 4A illustrates a detail flowchart of operation 1072 of FIG. 3A further receiving the ROM input communication;

FIG. 4B illustrates a detail flowchart of operation 1092 of FIG. 3B further sending the synthesizable RECLN description;

FIG. 4C illustrates a simplified block diagram in accordance with the invention of one preferred implementation of the method illustrated in FIG. 2A;

FIG. 5 illustrates a preferred method 1200 of doing business generating synthesizable RECLN descriptions in accordance with the invention and the operations of FIGS. 2A to 4B;

FIG. 6 illustrates a simplified block diagram in accordance with the invention of one preferred implementation of the business method illustrated in FIG. 5;

FIG. 7A illustrates a detail flowchart of operation 1032 of FIG. 2A further receiving the ROM input communication;

FIG. 7B illustrates a detail flowchart of operation 1302 of FIG. 7A further receiving the ROM pattern communication;

FIG. 8A illustrates a detail flowchart of operation 1312 of FIG. 7A further receiving the ROM vector communication;

FIG. 8B illustrates a detail flowchart of operation 1112 of FIG. 3C further ordering the ROM synthesis order 5040;

FIG. 9A illustrates a detail flowchart of operation 1112 of FIGS. 3C and 5 further ordering the ROM synthesis order;

FIG. 9B illustrates a detail flowchart of operation 1462 of FIG. 9A further ordering by the offer-acceptance;

FIG. 10A illustrates a detail flowchart of operation 1452 of FIG. 9A further ordering by the request-for-quote;

FIG. 10B illustrates a detail flowchart of operation 1452 of FIG. 9A further ordering by the offer-counteroffer-acceptance;

FIG. 11A illustrates various further components of a ROM synthesis order 5040 of FIG. 6 as contemplated by the invention;

FIG. 11B illustrates a receiving collection 1600 of steps 1482, 1512, 1532, 1552, and 1572, found in FIGS. 9A to 10B;

FIG. 11D illustrates at least one of ROM input communication 5040 and/or synthesizable RECLN description 5020 of FIGS. 4C and 6, comprising of at least one of the documents 5090, 5092 and 5094;

FIG. 11E illustrates a version of at least one document 5090-5094 of ROM input communication 5030 of FIG. 11D, comprising of at least one the versions 5102 to 5110;

FIG. 11F illustrates a portable memory device collection 5120 as used herein;

FIG. 12A illustrates a detail flowchart of a member of receiving collection 1600 of FIG. 11B further performing the receiving member step;

FIG. 12B illustrates a detail flowchart of a member of sending collection 1610 of FIG. 11C further performing the sending member step;

FIG. 13 illustrates a detail flowchart of operation 1072 of FIG. 3A further receiving the ROM input communication from the first user by at least one of the operations;

FIG. 14 illustrates a detail flowchart of operation 1092 of FIG. 3B further sending the synthesizable RECLN description to the second user by at least one of the operations;

FIG. 15A illustrates a detail flowchart of operation 1062 of FIG. 2B further verifying the first RECLN description;

FIG. 15B illustrates a detail flowchart of operation 1062 of FIG. 2B further verifying the first RECLN description including at least operation 1852 and one of the other operations;

FIG. 16A illustrates a detail flowchart of operation 1012 of FIG. 2A further using the logic minimizer by performing at least one of these operations;

FIG. 16B illustrates a detail flowchart of operation 1022 of FIG. 2A further converting the logic minimization by performing at least one of these operations;

FIG. 17A illustrates a flowchart of a method 2300 generating a netlist based upon a circuit description incorporating the synthesizable RECLN description of FIGS. 2A, 4C, 5, and 6;

FIG. 17B illustrates a detail flowchart of operation 2304 of FIG. 17A further integrating the synthesizable RECLN description;

FIG. 18 illustrates a mechanism contemplated by the invention generating at least one of the collection comprising a circuit description 5182, a netlist 5184, a circuit layout 5186, a mask set 5188, an unpackaged IC wafer 5190, an integrated circuit 5192 and a systems product 5194;

FIG. 19 illustrates a flowchart of a method of generating at least one of circuit layout 5186, mask set 5188, unpackaged IC wafer 5190, integrated circuit 5192 and systems product 5194, including at least one operation of this flowchart;

FIG. 20 illustrates a flowchart of systems product 5194 of FIG. 18 providing at least one of the operations of this Figure;

FIG. 21 illustrates a method of generating revenue based upon the mask set 5188 of FIGS. 18 and 19;

FIG. 22 illustrates a system implementing the method 2600 generating a revenue based upon the mask set of FIG. 21;

FIG. 23A illustrates a method 2670 making an installation mechanism for the process 1000 of FIG. 2A and the process 1200 of FIG. 5;

FIG. 23B illustrates a detail flowchart of operation 2692 of FIG. 23A further integrating the computer programming language document;

FIG. 24 illustrates a detail flowchart of operation 2702 of FIG. 23 further writing the installation procedure by at least one of the operations of this Figure;

FIG. 25A illustrates what is referred to by a computer programming language collection 5300;

FIG. 25B illustrates an apparatus implementing the method 2670 of FIG. 23A;

FIG. 25C illustrates the virtual transport component collection 5350 including files 5352, folders 5354, hyperlinks 5356 and download sites 5358;

FIG. 26A illustrates a method 2770 of making engine 3000 of FIG. 4C and/or engine 3200 of FIG. 6 generating the synthesizable RECLN description 5020 emulating the ROM using the installation mechanism 5334;

FIG. 26B illustrates a detail flowchart of method 2770 of FIG. 26A further making the engine;

FIG. 27A illustrates a system making engines 3000 and/or 3200 by implementing the method 2770 of FIG. 26A;

FIG. 27B illustrates a system making engines 3000 and/or 3200 by implementing the method 2770 of FIGS. 26A and 26B;

FIG. 28 illustrates a detail flowchart of operation 1012 of FIG. 2A further using the logic minimizer;

FIG. 29A illustrates a detail flowchart of operation 2852 of FIG. 28 further using further-logic-minimization to generate a second logic minimization whenever the need-for-further-minimization;

FIG. 29B illustrates a detail flowchart of operation 2896 of FIG. 29A further using further-logic-minimization to generate a second logic minimization;

FIG. 29C illustrates a detail flowchart of operation 2852 of FIG. 28 further using further-logic-minimization;

FIG. 30A illustrates a detail flowchart of operation 2862 of FIG. 28 further generating the logic minimization; and

FIG. 30B illustrates a detail flowchart of operation 2962 of FIG. 30A further comparing the first critique and the second critique.

### DETAILED DESCRIPTION OF DRAWINGS

The invention includes combinatorial logic networks emulating a ROM known herein as ROM Emulator Combinatorial Logic Networks (RECLN). The RECLN receives at least two address input signals and generates at least one data output signal to emulate a ROM receiving the same address input signals and presenting essentially the same output data signals.

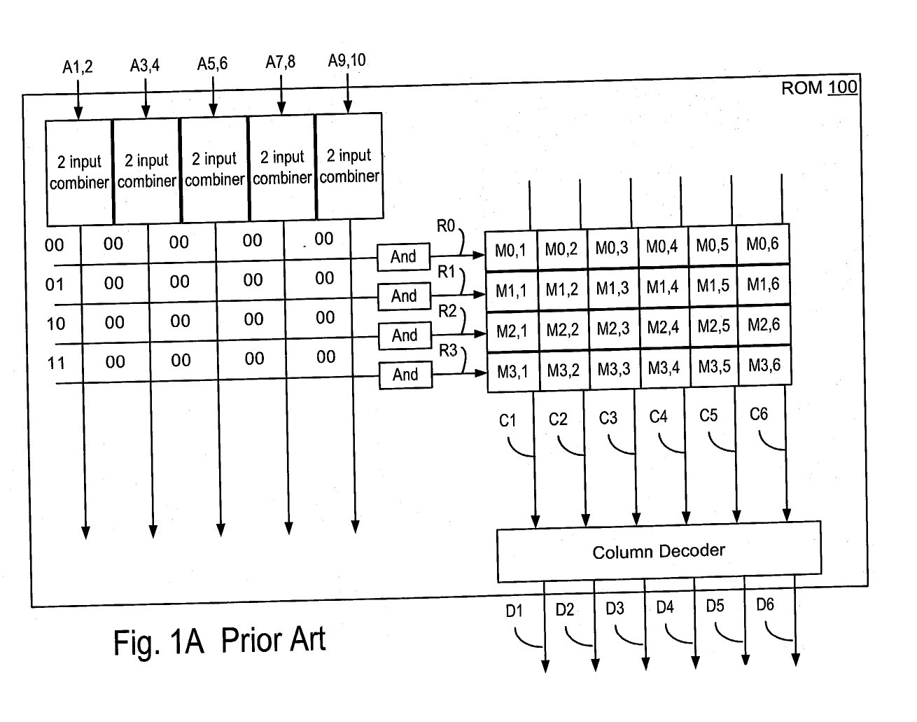

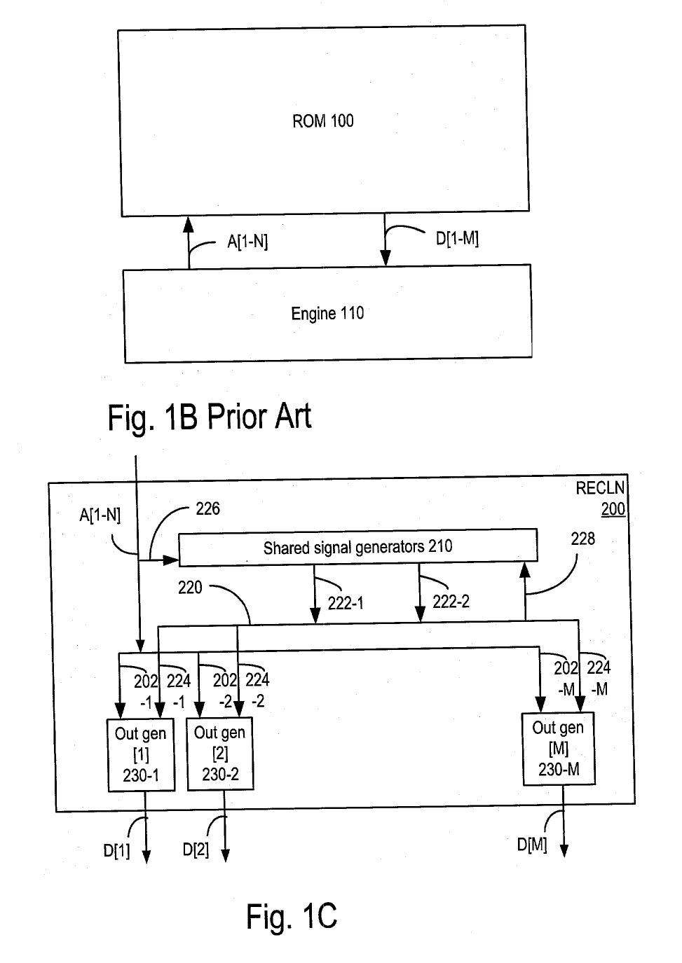

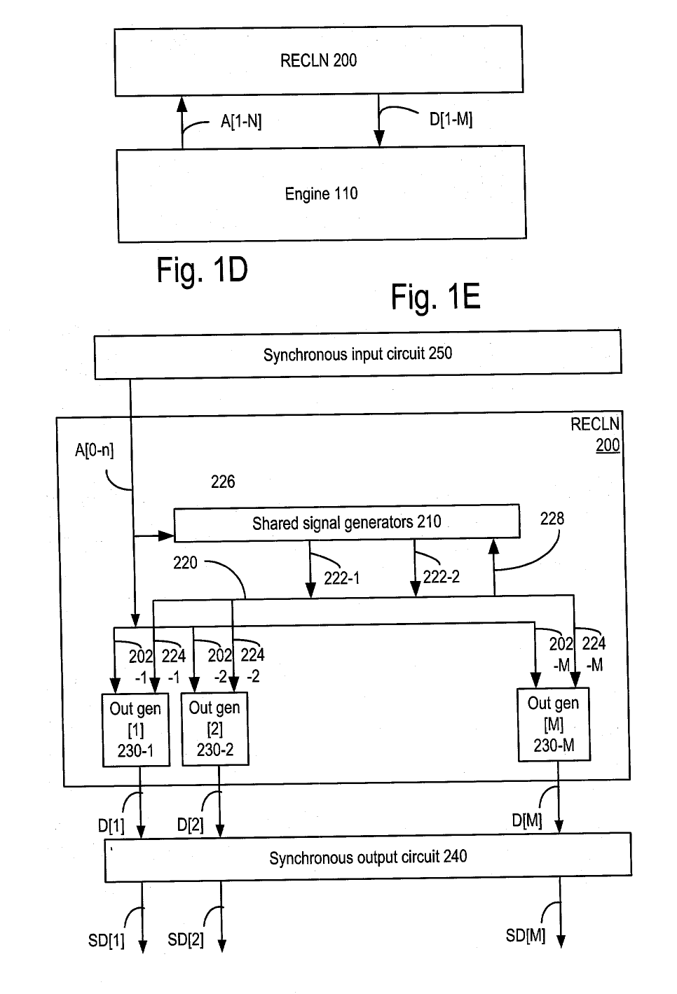

FIG. 1C illustrates an RECLN 200 including at least an output generator collection containing an output generator 230-k for each data output D[k] receiving 202-k at least some of the input signals A[1-n] and possibly receiving 224-k at least some shared signals 220 from 222-1 and/or 222-2 shared signal generator collection 220.

A collection of input signals A[1-n] are received and presented to an output generator 230-k for each D[k] of the output signals D[1-m]. Each output generator 230-k consists essentially of a first combinatorial logic network, each receiving the generator input collection 202-k and generating the data signal D[k]. The generator input collection may vary for each output generator 230-k. Generator input collection signals 202-k belong to an internal signal collection including at least the received address signals A.

The invention often preferably includes a shared signal generator collection 210 comprising at least one shared signal generator receiving at least one member of the internal signal collection to create a shared generator input collection and generating at least one shared signal 222-1. In these circumstances, the internal signal collection further includes all of the shared signals 220. Often, the shared signal generator collection 210 preferably generates more than one shared signal, 222-2. Each generator in the shared signal generator collection 210 receives at least one input from the internal signal collection, which may include input from received address signals 226 and/or a shared signal 228.

At least one of the shared signal collection 210 members is included in the first combinatorial logic network of a first output generator and in the first combinatorial logic network of a second output generator.

Note that these output generators consist essentially of the combinatorial logic networks. Additional circuitry may be incorporated into one or more output generators which are essentially invisible to the normal logic operation of the output generator. Examples of such additional circuitry include, but are not limited to, substrate biasing circuitry, power distribution network circuitry, noise suppression circuitry, and built in test circuitry. Built in test circuitry may include additional signals operationally used only testing conditions, such as product term separator signals for programmable logic arrays, and scan path control and data signals. Note that scan path circuitry may include buried registers, which are passive during normal operation of the RECLN 200.

The invention further preferably includes at least one the first combinatorial logic networks implemented as one of the following: at least part of a gate array, a standard cell network, a custom logic cell network, at least part of a programmable logic array network, and at least part of a logic cell array network.

By way of example, the following logic equations summarize various combinations of circumstances contemplated by the invention:

| | |
|---|---|
| D[1] = A[1], | D[2] = not A[1], |
| D[3] = A[1] and A[2], | D[4] = A[1] nand A[2], |
| D[5] = A[1] or A[2], | D[6] = A[1] nor A[2], |
| D[7] = A[1] xor A[2], | D[7] = A[1] xnor A[2], |
| D[9] = Mux(A[1], A[2]; by A[3]), | D[10] = not Mux(A[1], A[2]; by |
| | A[3]), |

Note that Mux(A[1], A[2]; by A[3]) provides A[1] when A[3]=0, and A[2] when A[3]=1.

By way of example, the following logic equations for shared signals Sh[1] and Sh[2] summarize various combinations of circumstances contemplated by the invention:

| | |
|---|---|
| D[11] = Sh[1], | D[12] = not Sh[1], |
| D[13] = Sh[1] and A[2], | D[14] = Sh[1] nand Sh[2], |
| D[15] = Sh[1] or Sh[2], | D[16] = A[1] nor Sh[2], |
| D[17] = Sh[1] xor A[2], | D[17] = Sh[1] xnor Sh[2], |
| D[19] = Mux(Sh[1], Sh[2]; by A[3]), | D[20] = not Mux(A[1],A[2]; by |
| | Sh[2]), |

Also byway of example, the following logic equations for shared signals Sh[1], Sh[2], and Sh[3] summarize various combinations of circumstances contemplated by the invention:

| | |
|---|---|
| Sh[3] = Sh[1], | Sh[3] = not Sh[1], |
| Sh[3] = Sh[1] and A[2], | Sh[3] = Sh[1] nand Sh[2], |
| Sh[3] = Sh[1] or Sh[2], | Sh[3] = A[1] nor Sh[2], |
| Sh[3] = Sh[1] xor A[2], | Sh[3] = Sh[1] xnor Sh[2], |
| Sh[3] = Mux(Sh[1], Sh[2]; by A[3]), | Sh[3] = not Mux(A[1], A[2]; by |
| | Sh[2]), |

The invention may also include a propagation delay output generator receiving at least one input signaling start of propagation and generating output-ready for the generated data signals. Such preferred embodiments are useful when the surrounding circuitry supports a self-timed control protocol.

FIG. 1D illustrates using an RECLN circuit 200 replacing ROM circuit 100.

Engine 110 is coupled by the address input signals A[1-N] and by the data signals D[1-M] to the RECLN 200. Engine 110 provides the address input signals A[1-N] to the RECLN 110. RECLN 110 generates the data signals D[1-M] based upon the provided address input signals A[1-N].

FIG. 1E illustrates a synchronous ROM emulator circuit including RECLN circuit 200 as part of a example of FIG. 1D.

Various preferred embodiments of engine 110 may include either synchronous input circuit 250 and/or synchronous output circuit 240. Synchronous input circuit 250 provides a synchronizing interface capturing address input signals A[1-N]. Synchronous output circuit 240 provides data outputs D[1-M] based upon a synchronization scheme within engine 110 as SD[1-M].

As used herein a wire refers to a path connecting nodes of a circuit which carries a state between the connected nodes and/or refers to a resonant cavity propagating information in terms of state between the connected nodes. A wire may be made out of metal, an optical chamber, or a tunnel path through a molecular substrate. A wire bundle is a collection of at least one wire.

In the following figures will be found flowcharts of at least one method of the invention possessing arrows with reference numbers. These arrows will signify of flow of control and sometimes data which supports implementations not only as at least one program or program thread executing upon a computer, but also, as hyperlinks, inferential links in an inferential engine, a state transition in a finite state machine and as a dominant learned response within a neural network.

The operation of starting a flowchart refers to at least one of the following: entering a subroutine ir a macro instruction sequence in a computer, entry into a deeper node of an inferential graph, directing a state transition in a finite state machine, possibly while pushing a return state, and triggering a collection of neurons in a neural network.

The exit operation in a flowchart refers to at least one or more of the following: the completion of those operations, which may result in a subroutine return or the end of a macro-instruction, traversal of a higher node in an inferential graph, popping of a previously stored state in a finite state machine, and return to dormancy of the firing neurons of the neural network.

A computer as used herein will include, but is not limited to an instruction processor; wherein the instruction processor includes at least one instruction processing element and at least one data processing element, each data processing element controlled by at least one instruction processing element.

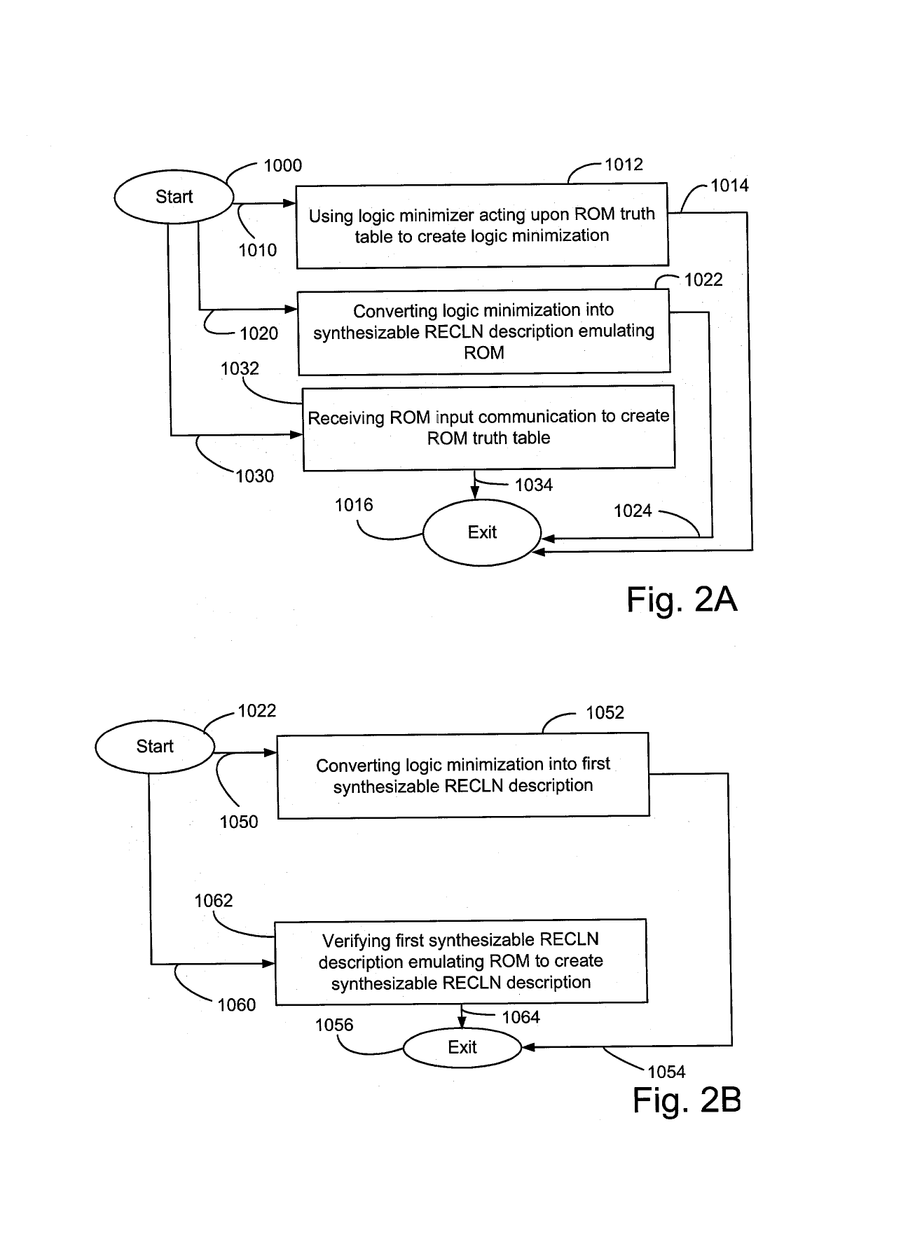

FIG. 2A illustrates a flowchart of operation 1000 of a method generating a synthesizable RECLN description emulating a ROM.

Operation 1012 performs using a logic minimizer acting upon a ROM truth table to create a logic minimization. Operation 1022 performs converting the logic minimization into the synthesizable RECLN description emulating the ROM.

The invention may further include operation 1032. Operation 1032 performs receiving a ROM input communication to create the ROM truth table.

FIG. 2B illustrates a detail flowchart of operation 1022 of FIG. 2A further converting the logic minimization into the synthesizable RECLN description.

Operation 1052 performs converting the logic minimization into a first RECLN description. Operation 1062 performs verifying the first RECLN description emulating the ROM to create the synthesizable RECLN description.

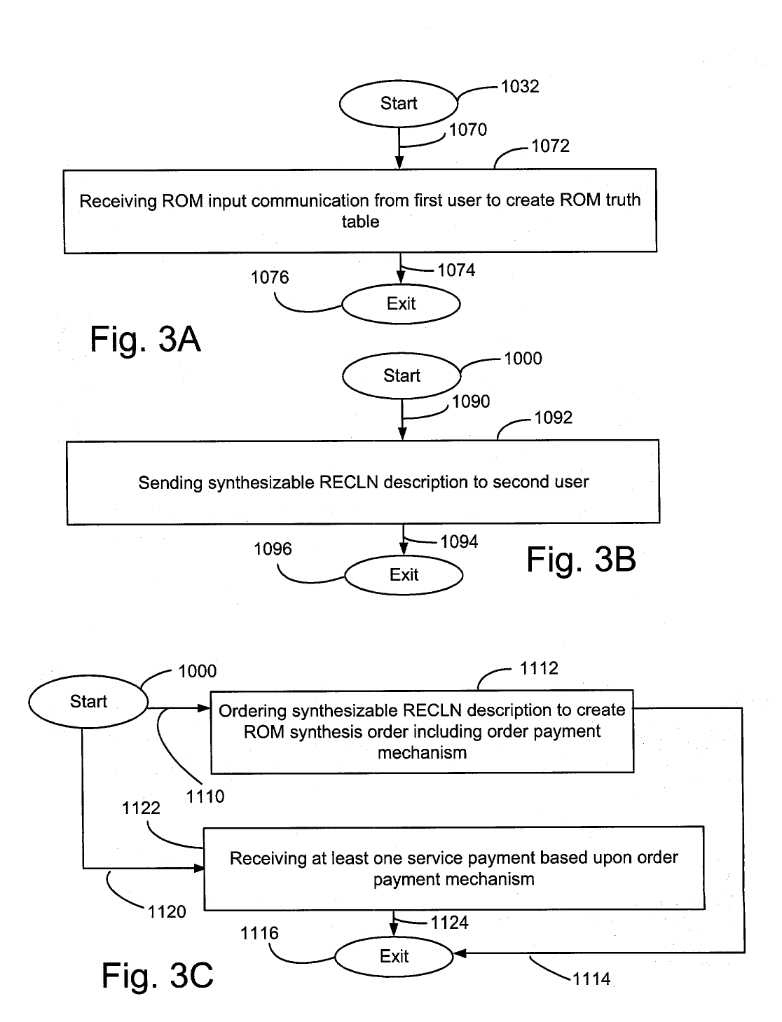

FIG. 3A illustrates a detail flowchart of operation 1032 of FIG. 2A further receiving the ROM input communication.

Operation 1072 performs receiving the ROM input communication from a first user to create the ROM truth table.

Operation 1092 performs sending the synthesizable RECLN description to a second user.

FIG. 3C illustrates a detail flowchart of method 1000 of FIG. 2A further generating the synthesizable RECLN description.

Operation 1112 performs ordering the synthesizable RECLN description to create a ROM synthesis order including an order payment mechanism. The invention may further include operation 1122, which performs receiving at least one service payment based upon the order payment mechanism.

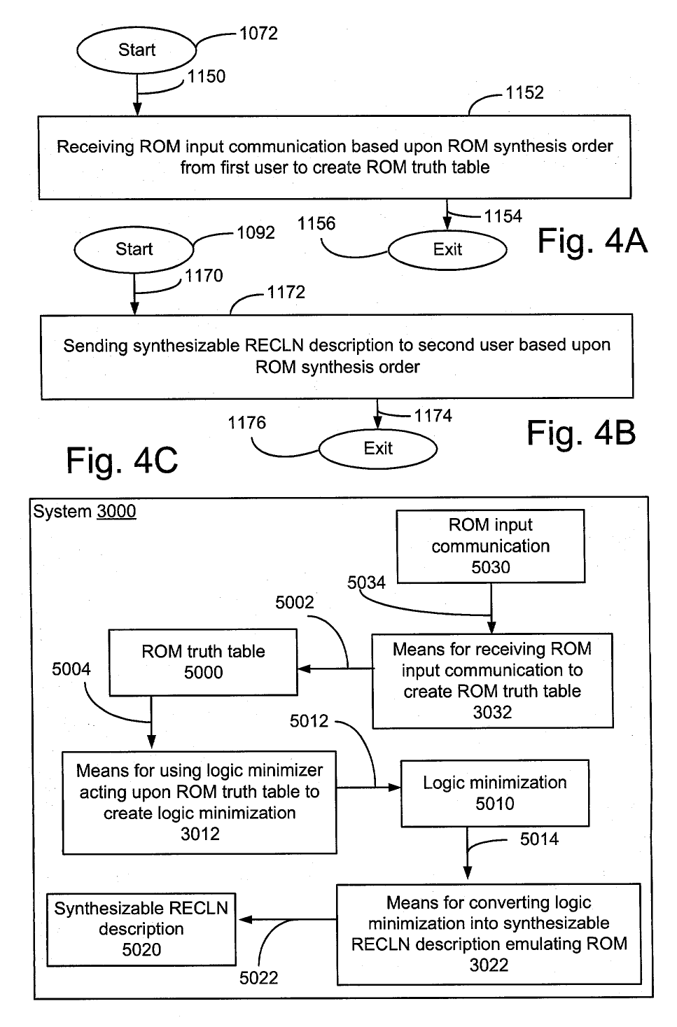

FIG. 4A illustrates a detail flowchart of operation 1072 of FIG. 3A further receiving the ROM input communication.

Operation 1152 performs receiving the ROM input communication based upon the ROM synthesis order from the first user to create the ROM truth table.

FIG. 4B illustrates a detail flowchart of operation 1092 of FIG. 3B further sending the synthesizable RECLN description.

Operation 1172 performs sending the synthesizable RECLN description to the second user based upon the ROM synthesis order.

FIG. 4C illustrates a simplified block diagram in accordance with the invention of one preferred implementation of the method illustrated in FIG. 2A.

The invention includes means 2012 using a logic minimizer acting upon 5004 ROM truth table 5000 to create 5012 logic minimization 5010. Logic minimization 5010 is presented 5014 to means 2022 converting logic minimization 5010 into 5022 a synthesizable RECLN description 5020.

The invention may further include a ROM input communication 5030 presented to means 2032 for receiving the ROM input communication 5030 to create 5002 the ROM truth table 5000.

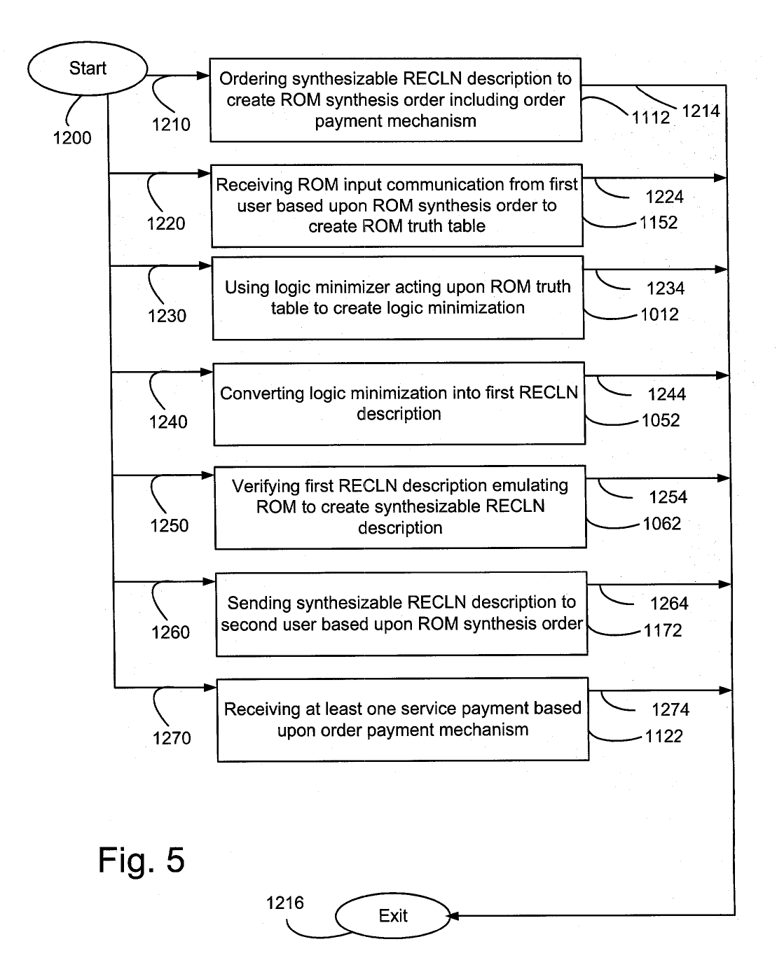

FIG. 5 illustrates a preferred method 1200 of doing business generating synthesizable RECLN descriptions in accordance with the invention and the operations of FIGS. 2A to 4B.

Operation 1112 performs ordering the synthesizable RECLN description to create a ROM synthesis order including an order payment mechanism. Operation 1152 performs receiving a. ROM input communication from a first user based upon the ROM synthesis order to create the ROM truth table. Operation 1012 performs using a logic minimizer acting upon a ROM truth table to create a logic minimization. Operation 1052 performs converting the logic minimization into a first RECLN description. Operation 1062 performs verifying the first RECLN description emulating the ROM to create the synthesizable RECLN description. Operation 1172 performs sending the synthesizable RECLN description to a second user based upon the ROM synthesis order. Operation 1122 performs receiving at least one service payment based upon the order payment mechanism.

The synthesizable RECLN description 5020 is a product of the process of FIGS. 2A and 5.

The service payment 5060 is a product of the process of FIGS. 3C and 5.

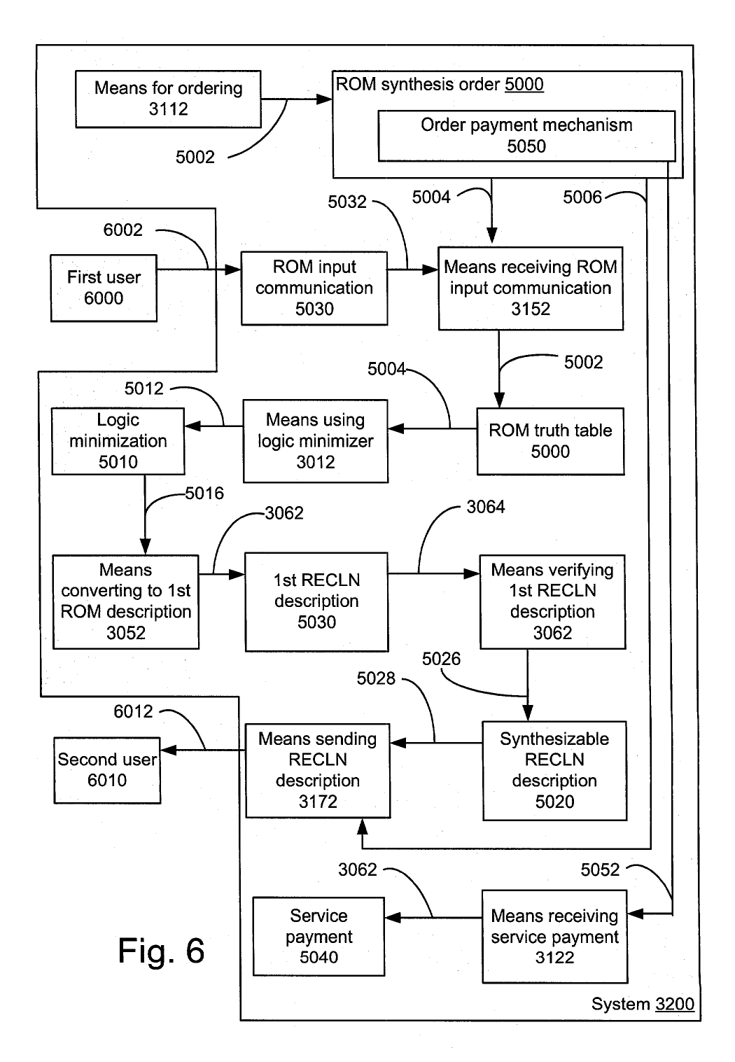

FIG. 6 illustrates a simplified block diagram in accordance with the invention of one preferred implementation of the business method illustrated in FIG. 5.

Means 2112 for ordering creates 5042 ROM synthesis order 5040 including order payment mechanism 5050.

First user 2100 provides 3102 ROM input communication 5030, which is presented to means 2112 receiving the ROM input communication 5030 based upon 5044 ROM synthesis order 5040, to create 5002 the ROM truth table 5000.

As in FIG. 4C, ROM truth table 5000 is presented to means 2012 for using a logic minimizer acting upon ROM truth table 5000 to create 5012 logic minimization 5010.

In FIG. 4C, logic minimization 5010 is presented 5014 to means 2022 converting logic minimization 5010 into 5022 a synthesizable RECLN description 5020.

In contrast, FIG. 6 illustrates logic minimization 5010 presented 5016 to means 2052 converting logic minimization 5010 into 5052 a first RECLN description 5050. First RECLN description 5050 is presented 5054 to means 2062 verifying the first RECLN description to create 3026 synthesizable RECLN description 5020.

Means 2172 for sending 3112 presents 3028 synthesizable RECLN description 5020, which performs its operation based upon 5046 ROM synthesis order 5040.

Service payment 5060 is created 5062 by means 2172 for receiving at least one service payment based upon 5052 the order payment mechanism 5050 of ROM synthesis order 5040.

First user 6000 may by the same as second user 6010. One or both of these users may include at least one of the following: a human being, a computer, a network address, a authentication code, and a software agent residing upon a finite state machine.

ROM input communication 5030 may include one or more of the following: the ROM truth table 5000, a ROM loader pattern, and a ROM vector set.

The ROM pattern may further be backward compatible with a memory loader format belonging to a load format collection comprising a hex loader format and a binary loader format. Hex loader formats often use hexadecimal digits portrayed as characters in text files. A binary loader format uses packed binary records to provide loaders for disk and windowing operating systems such as Linux.

Binary loader formats have the advantage of requiring the least memory overhead to load a given amount of data. Hex loader formats are easily read by humans and relatively easy to process. Note that while loader formats have been developed based around octal digits as characters, such loader format will be considered a specialized version of a hex loader format herein.

The ROM vector set may be further backward compatible with a logic simulator vector format belonging to a hexadecimal vector format and a bit vector format and a binary vector format. A hexadecimal vector format will include not only hexadecimal but also other text-numeric notations such as octal. A bit vector represents all signals as text characters representing bits, often further supporting don't care conditions. A binary vector format uses packed vectors, utilizing the least amount of memory to provide a given amount of data.

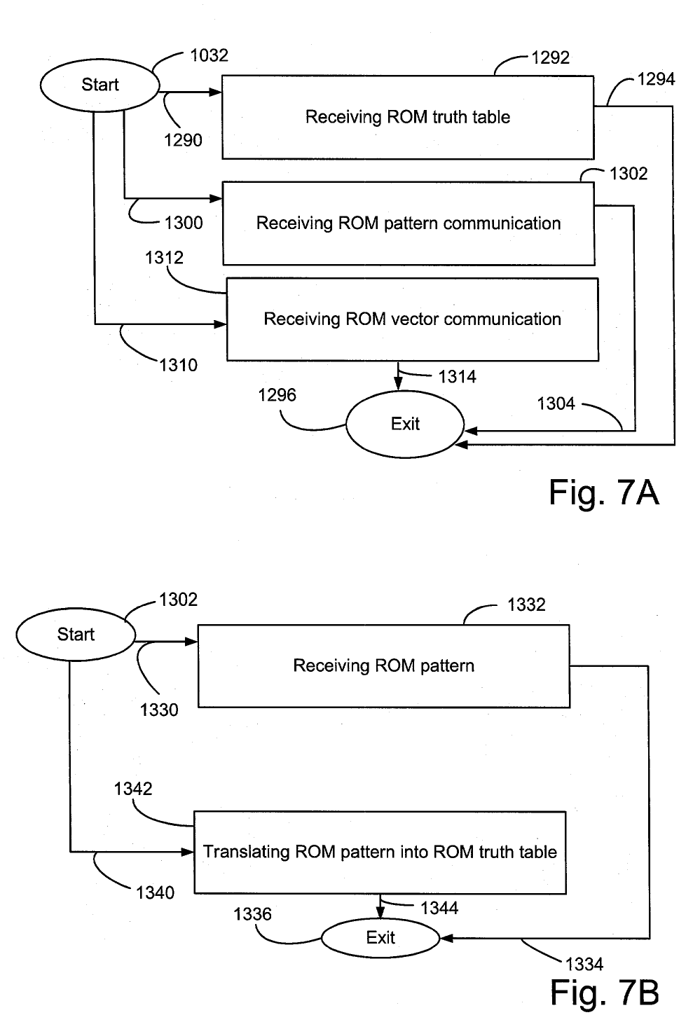

FIG. 7A illustrates a detail flowchart of operation 1032 of FIG. 2A further receiving the ROM input communication.

Operation 1292 performs receiving the ROM truth table 5000. Operation 1302 performs receiving a ROM pattern communication. Operation 1312 performs receiving a ROM vector communication.

FIG. 7B illustrates a detail flowchart of operation 1302 of FIG. 7A further receiving the ROM pattern communication.

Operation 1332 performs receiving a ROM pattern. Operation 1342 performs translating the ROM pattern into the ROM truth table 5000.

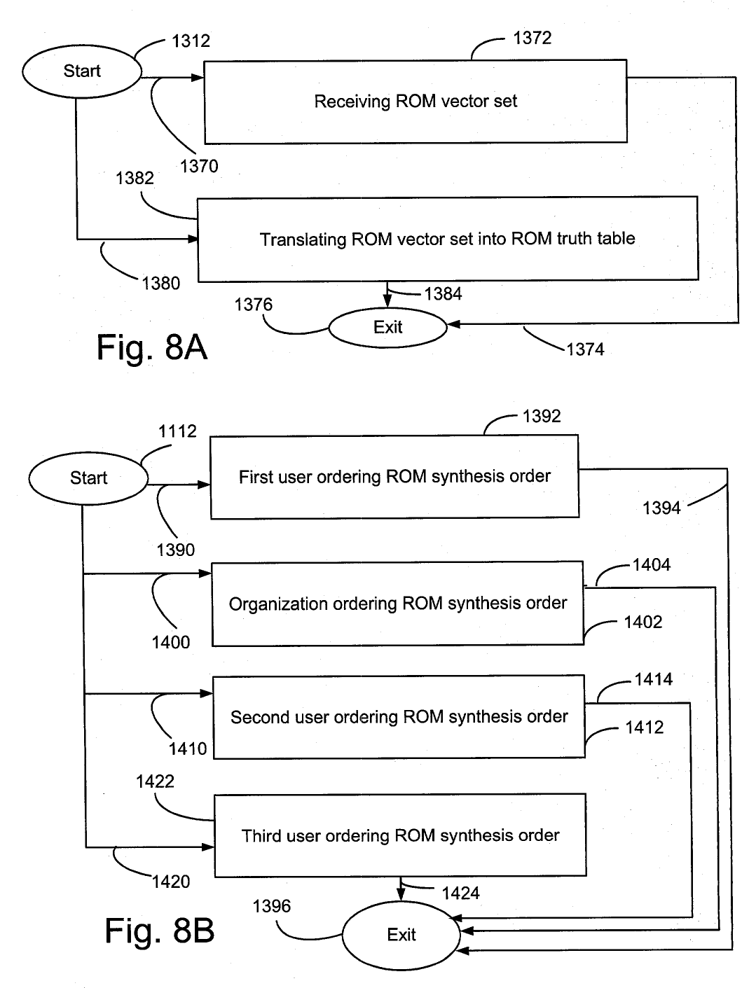

FIG. 8A illustrates a detail flowchart of operation 1312 of FIG. 7A further receiving the ROM vector communication.

Operation 1372 performs receiving a ROM vector set. Operation 1382 performs translating the ROM vector set into the ROM truth table.

An organization may employ at least one of the first user 3100, the second user 1310 and a third user.

FIG. 8B illustrates a detail flowchart of operation 1112 of FIG. 3C further ordering the ROM synthesis order 5040.

Operation 1392 performs the first user ordering the ROM synthesis order. Operation 1402 performs the organization ordering the ROM synthesis order. Operation 1412 performs the second user ordering the ROM synthesis order. Operation 1422 performs the third user ordering the ROM synthesis order.

Note that the organization may be any of the following: a human individual operating for profit, a sole proprietorship, a corporation, a partnership, a government, a non-profit organization performing work for hire, the first user, the second user, and the third user.

The ROM synthesis order 5040 may involve a subscription providing a service generating one or more the synthesizable RECLN descriptions 5020.

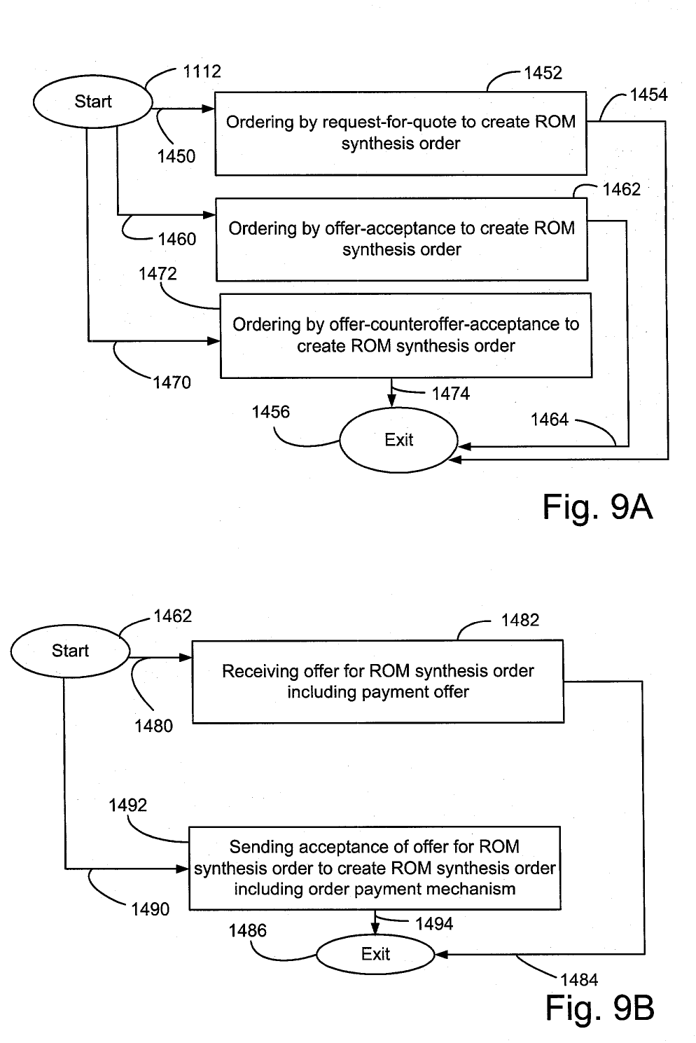

FIG. 9A illustrates a detail flowchart of operation 1112 of FIGS. 3C and 5 further ordering the ROM synthesis order.

Operation 1452 performs ordering by a request-for-quote to create the ROM synthesis order. Operation 1462 performs ordering by an offer-acceptance to create the ROM synthesis order. Operation 1472 performs ordering by an offer-counteroffer-ac ceptance to create the ROM synthesis order.

FIG. 9B illustrates a detail flowchart of operation 1462 of FIG. 9A further ordering by the offer-acceptance.

Operation 1482 performs receiving an offer for the ROM synthesis order including a payment offer. Operation 1492 performs sending an acceptance of the offer for the ROM synthesis order to create the ROM synthesis order including the order payment mechanism based upon the payment offer.

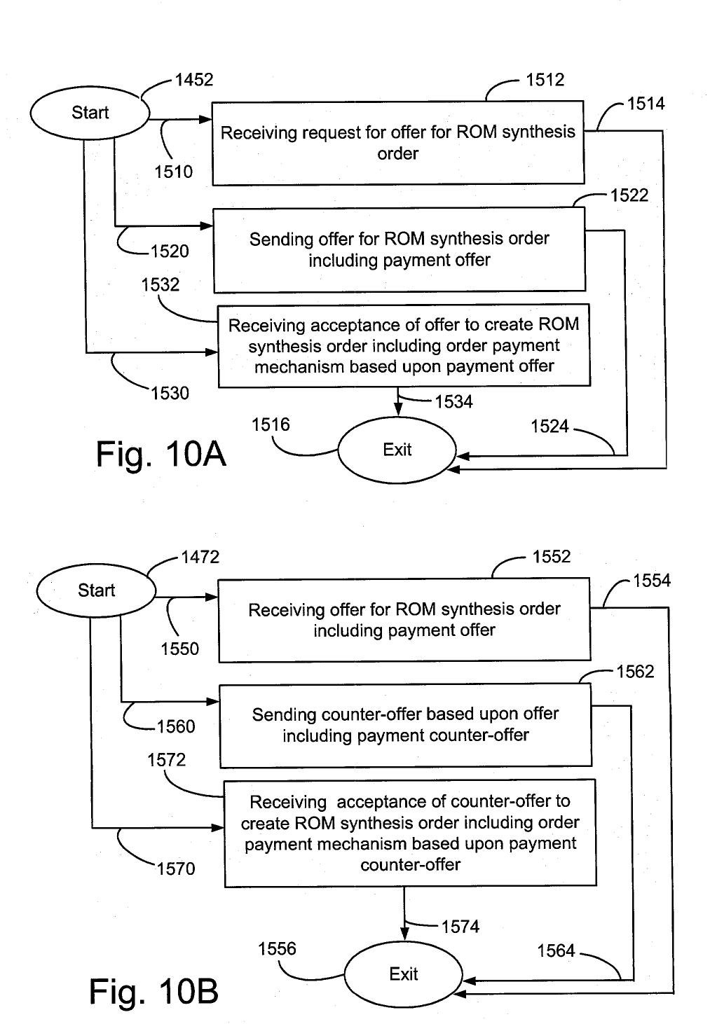

FIG. 10A illustrates a detail flowchart of operation 1452 of FIG. 9A further ordering by the request-for-quote.

Operation 1512 performs receiving a request for an offer for the ROM synthesis order. Operation 1522 performs sending an offer for the ROM synthesis order including a payment offer. Operation 1532 performs receiving an acceptance of the offer for the ROM synthesis order to create the ROM synthesis order including an order payment mechanism based upon the payment offer.

FIG. 10B illustrates a detail flowchart of operation 1452 of FIG. 9A further ordering by the offer-counteroffer-acceptance.

Operation 1542 performs receiving an offer for the ROM synthesis order including a payment offer. Operation 1552 performs sending a counter-offer based upon the offer including a payment counter-offer. Operation 1562 performs receiving an acceptance of the counter-offer to create the ROM synthesis order including the order payment mechanism based upon the payment counter-offer.

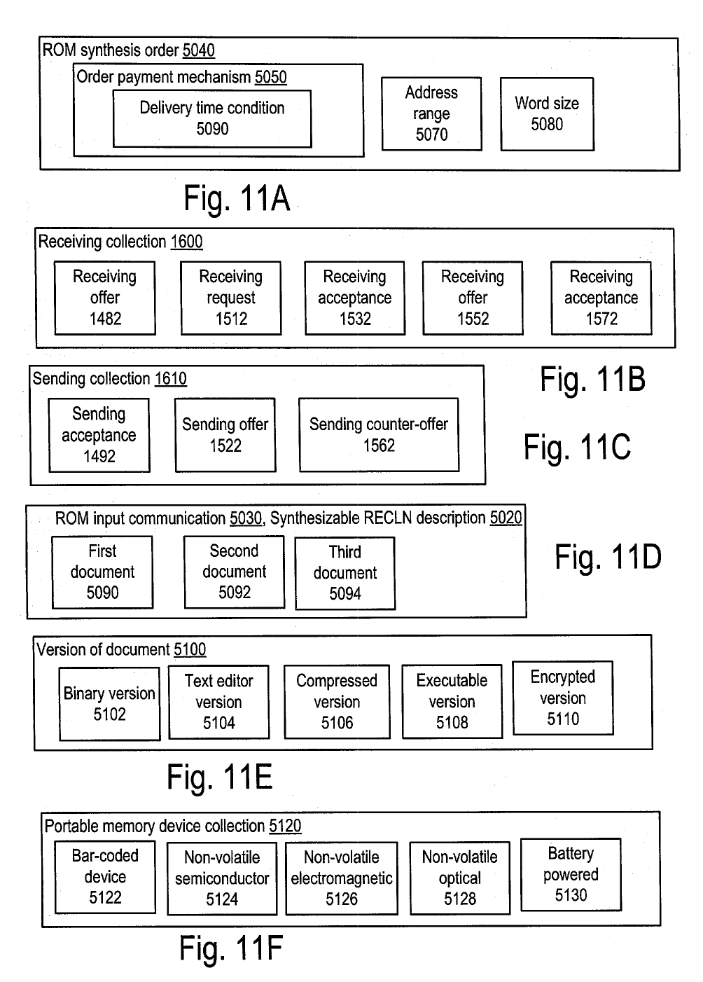

FIG. 11A illustrates various further components of a ROM synthesis order 5040 of FIG. 6 as contemplated by the invention.

The ROM synthesis order 5040 may further include at least one an address range 5070, a word size 5080, and a delivery time condition 5090 as part of the payment mechanism 5050.

FIG. 11B illustrates a receiving collection 1600 of steps 1482, 1512, 1532, 1552, and 1572, found in FIGS. 9A to 10B.

FIG. 11C illustrates a sending collection 1610 of steps 1492,1522, and 1562, found in FIGS. 9A to 10B.

As used herein, a communications collection will refer to a collection including at least ROM input communication 5040 and the synthesizable RECLN description 5020.

FIG. 11D illustrates at least one of ROM input communication 5040 and/or synthesizable RECLN description 5020 of FIGS. 4C and 6, comprising of at least one of the documents 5090, 5092 and 5094.

Note that at least one of the members of the communications collection may preferably include at least two documents.

At least one of the synthesizable RECLN description documents is preferably compatible with a form of at least one member of a simulation language collection comprising at least VHDL, Verilog, C, C++, matlab, and Java.

FIG. 11E illustrates a version of at least one document 5090-5094 of ROM input communication 5030 of FIG. 11D, comprising of at least one the versions 5102 to 5110.

A version of the communications collection member 5020 and/or 5040 document involves at least one member of a version collection 5100 including a binary version 5102 of the document, a text editor version 5104 of the document, a compressed version 5106 of the document, an executable version 5108 providing the document, and an encrypted version 5110 of the document.

FIG. 11F illustrates a portable memory device collection 5120 as used herein.

A portable memory device will belong to portable memory collection 5120 comprising a bar-coded device 5122, a non-volatile semiconductor memory device 5124, a non-volatile electro-magnetic memory device 5126, a non-volatile optical memory device 5128, and a battery powered portable memory device 5130. As used herein a battery includes at least one member of the collection comprising a rechargeable battery, a limited charge battery, and a fuel cell.

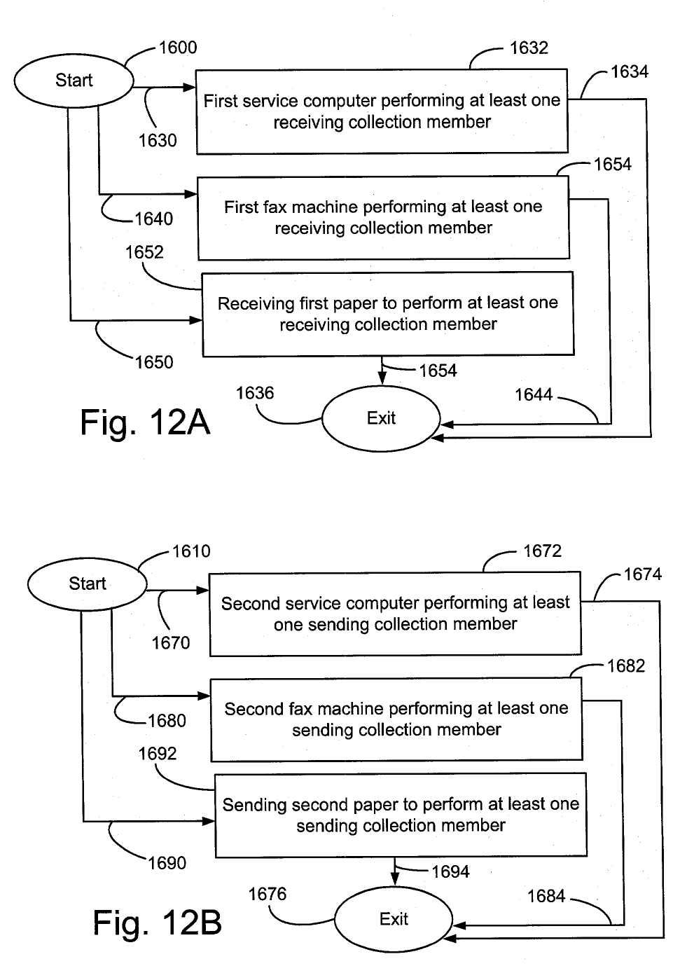

FIG. 12A illustrates a detail flowchart of a member of receiving collection 1600 of FIG. 1B further performing the receiving member step.

Operation 1632 performs a first service computer performing the receiving collection member. Operation 1642 performs a first fax machine performing the receiving collection member. Operation 1652 performs receiving a first paper to perform the receiving collection member.

FIG. 12B illustrates a detail flowchart of a member of sending collection 1610 of FIG. 11C further performing the sending member step.

Operation 1672 performs a second service computer performing the sending collection member. Operation 1682 performs a second fax machine performing the sending collection member. Operation 1692 performs sending a second paper to perform the sending collection member.

The first service computer may be preferred to be essentially the second service computer, performing both receiving collection member step(s) and the sending collection member step(s).

Similarly, the first fax machine may be essentially the second fax machine in some preferred embodiments.

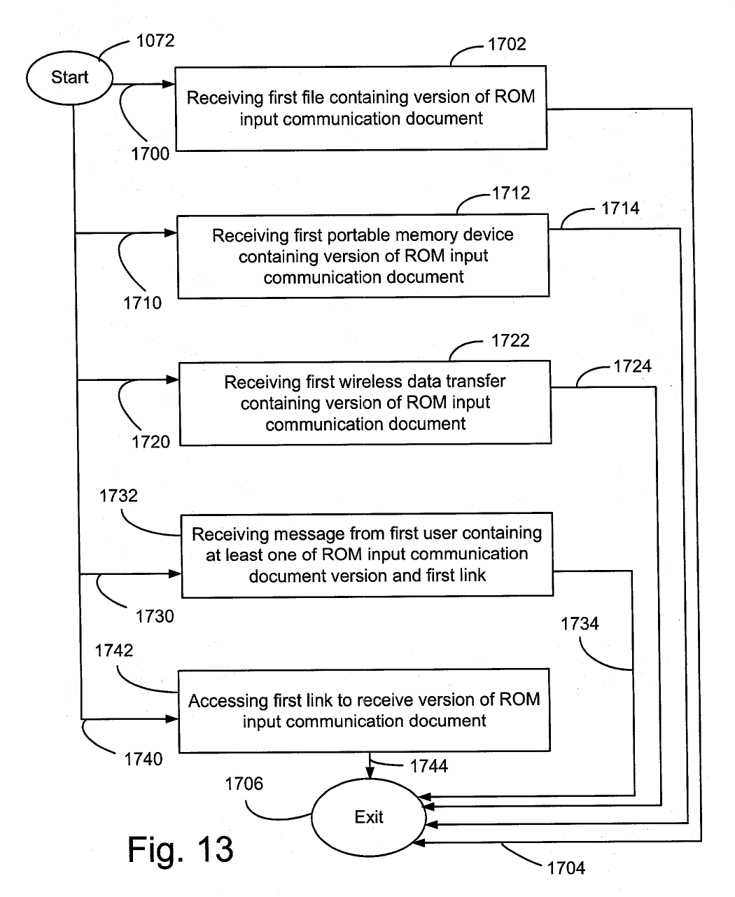

FIG. 13 illustrates a detail flowchart of operation 1072 of FIG. 3A further receiving the ROM input communication from the first user by at least one of the operations.

Operation 1702 performs receiving a first file containing a version of the ROM input communication document. Operation 1712 performs receiving a first portable memory device containing the version of the ROM input communication document. Operation 1722 performs receiving a first wireless data transfer containing the version of the ROM input communication document. Operation 1732 performs receiving a message from the first user containing at least one member of the collection comprising the version of the ROM input communication document and a first link. Operation 1742 performs accessing the first link to receive the version of the ROM input communication document.

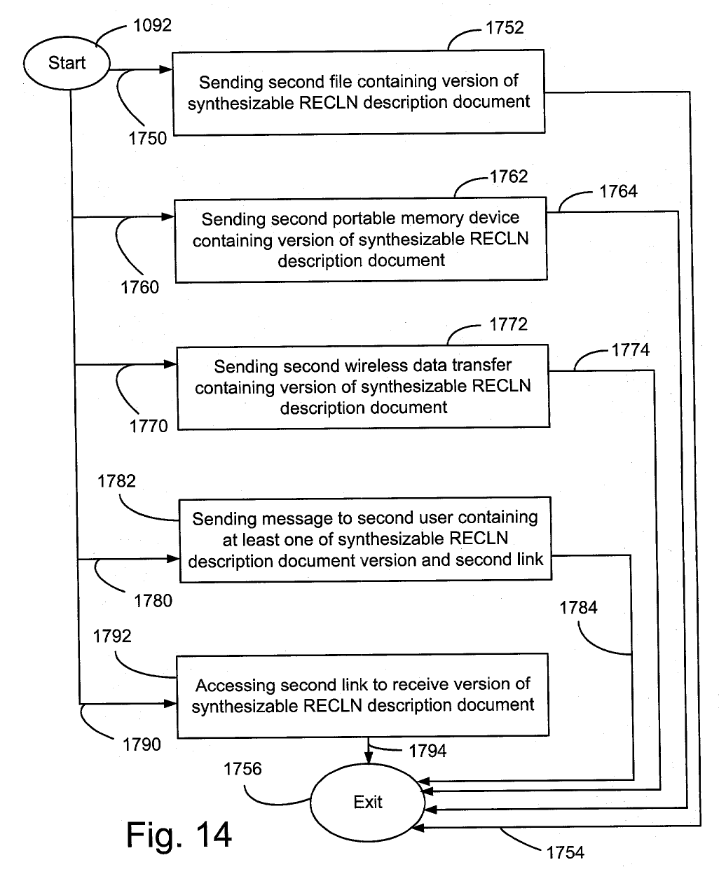

FIG. 14 illustrates a detail flowchart of operation 1092 of FIG. 3B further sending the synthesizable RECLN description to the second user by at least one of the operations.

Operation 1752 performs sending a second file containing a version of the synthesizable RECLN description document. Operation 1762 performs sending a second portable memory device containing the version of the synthesizable RECLN description document. Operation 1772 performs sending a second wireless data transfer containing the version of the synthesizable RECLN description document. Operation 1782 performs sending a message to the second user containing at least one member of the collection comprising the version of the synthesizable RECLN description document and a second link. Operation 1792 performs accessing the second link to receive the version of the synthesizable RECLN description document.

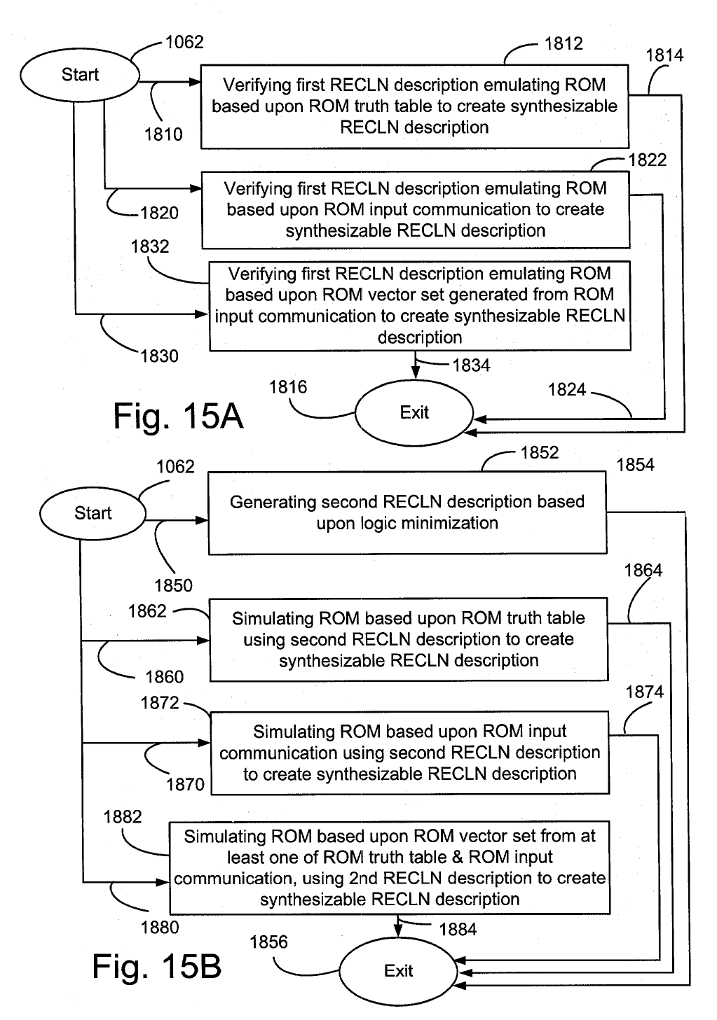

FIG. 15A illustrates a detail flowchart of operation 1062 of FIG. 2B further verifying the first RECLN description.

Operation 1812 performs verifying the first RECLN description emulating the ROM based upon the ROM truth table to create the synthesizable RECLN description. Operation 1822 performs verifying the first RECLN description emulating the ROM based upon the ROM input communication to create the synthesizable RECLN description. Operation 1832 performs verifying the first RECLN description emulating the ROM based upon a ROM vector set generated from the ROM input communication to create the synthesizable RECLN description.

FIG. 15B illustrates a detail flowchart of operation 1062 of FIG. 2B further verifying the first RECLN description including at least operation 1852 and one of the other operations.

Operation 1852 performs generating a second RECLN description based upon the logic minimization. Operation 1862 performs simulating the ROM based upon the ROM truth table using the second RECLN description to create the synthesizable RECLN description. Operation 1872 performs simulating the ROM based upon the ROM input communication using the second RECLN description to create the synthesizable RECLN description. Operation 1882 performs simulating the ROM based upon the ROM vector set generated from at least one member of the collection comprising the ROM truth table and the ROM input communication, using the second RECLN description to create the synthesizable RECLN description.

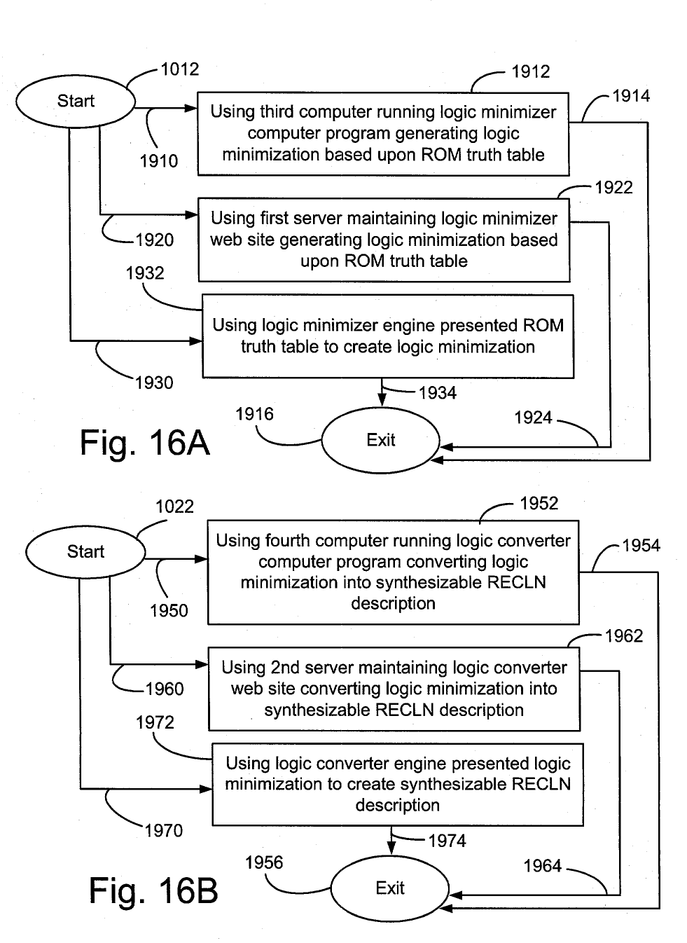

FIG. 16A illustrates a detail flowchart of operation 1012 of FIG. 2A further using the logic minimizer by performing at least one of these operations.

Operation 1912 performs using a third computer running a logic minimizer computer program generating the logic minimization based upon the ROM truth table. Operation 1922 performs using a first server maintaining a logic minimizer web site generating the logic minimization based upon the ROM truth table. Operation 1932 performs using a logic minimizer engine presented the ROM truth table to create the logic minimization.

FIG. 16B illustrates a detail flowchart of operation 1022 of FIG. 2A further converting the logic minimization by performing at least one of these operations.

Operation 1952 performs using a fourth computer running a logic converter computer program converting the logic minimization into the synthesizable RECLN description emulating the ROM based upon the ROM truth table. Operation 1962 performs using a second server maintaining a logic converter web site converting the logic minimization into the synthesizable RECLN description emulating the ROM based upon the ROM truth table. Operation 1972 performs using a logic converter engine presented the logic minimization to create the synthesizable RECLN description emulating the ROM based upon the ROM truth table.

The invention include embodiments in which any of the following individually or in any combination may be preferred: the logic minimizer engine and the logic converter engine belong to a logic engine, the third computer is essentially the fourth computer and/or the first server is essentially the second server.

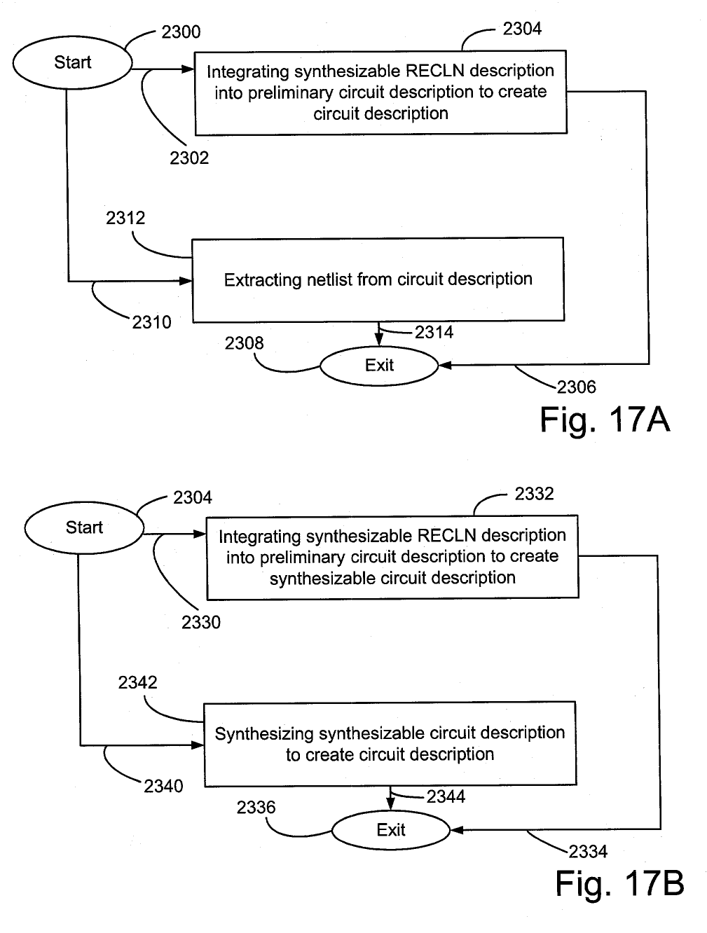

FIG. 17A illustrates a flowchart of a method 2300 generating a netlist based upon a circuit description incorporating the synthesizable RECLN description of FIGS. 2A, 4C, 5, and 6.

Operation 2304 performs integrating the synthesizable RECLN description into a preliminary circuit description to create the circuit description. Operation 2312 performs extracting the netlist from the circuit description.

FIG. 17B illustrates a detail flowchart of operation 2304 of FIG. 17A further integrating the synthesizable RECLN description.

Operation 2332 performs integrating the synthesizable RECLN description into the preliminary circuit description to create a synthesizable circuit description. Operation 2342 performs synthesizing the synthesizable circuit description to create the circuit description.

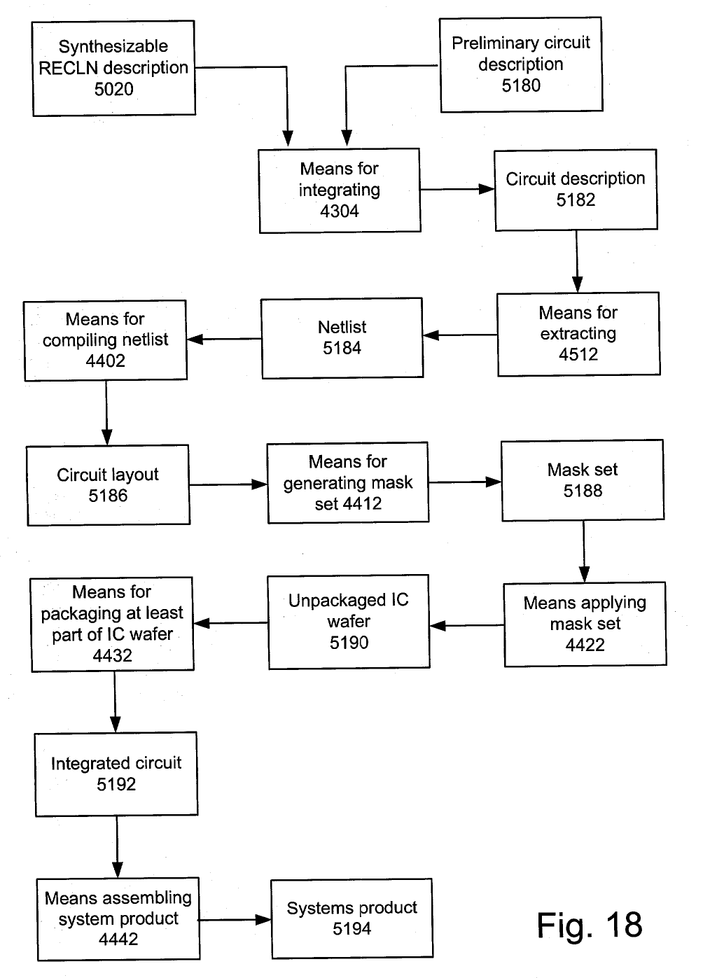

FIG. 18 illustrates a mechanism contemplated by the invention generating at least one of the collection comprising a circuit description 5182, a netlist 5184, a circuit layout 5186, a mask set 5188, an unpackaged IC wafer 5190, an integrated circuit 5192 and a systems product 5194.

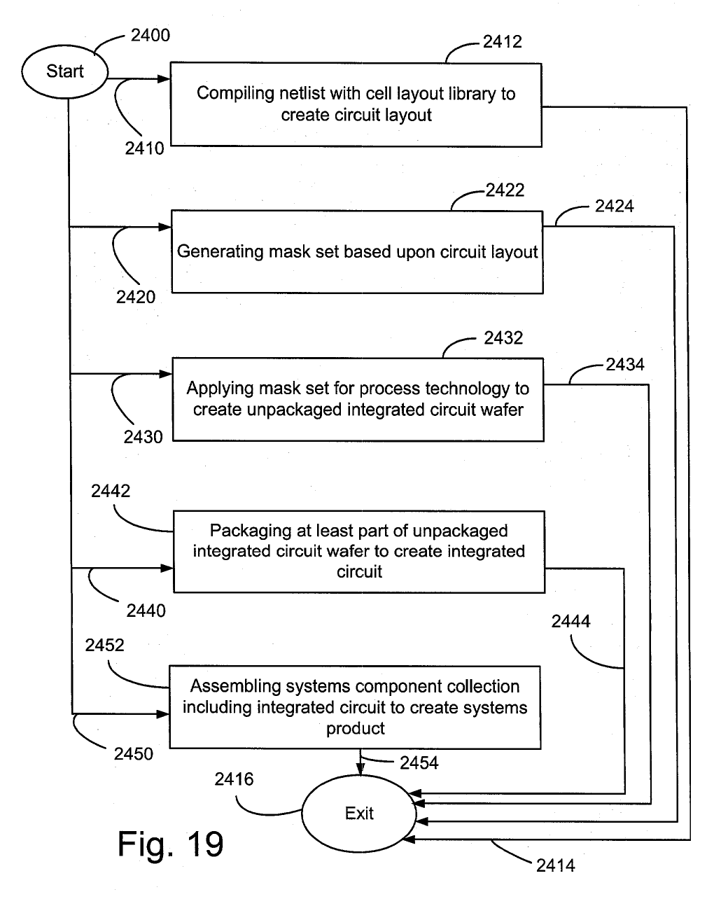

FIG. 19 illustrates a flowchart of a method of generating at least one of circuit layout 5186, mask set 5188, unpackaged IC wafer 5190, integrated circuit 5192 and systems product 5194, including at least one operation of this flowchart.

Operation 2402 performs compiling the netlist 5184 with at least one cell layout library to create the circuit layout 5186. Operation 2412 performs generating a mask set based upon at least the circuit layout. Operation 2422 performs applying the mask set for a process technology to create the unpackaged integrated circuit wafer. Operation 2432 performs packaging at least part of the unpackaged integrated circuit wafer to create the integrated circuit. Operation 2442 performs assembling a systems component collection including the integrated circuit to create the systems product.

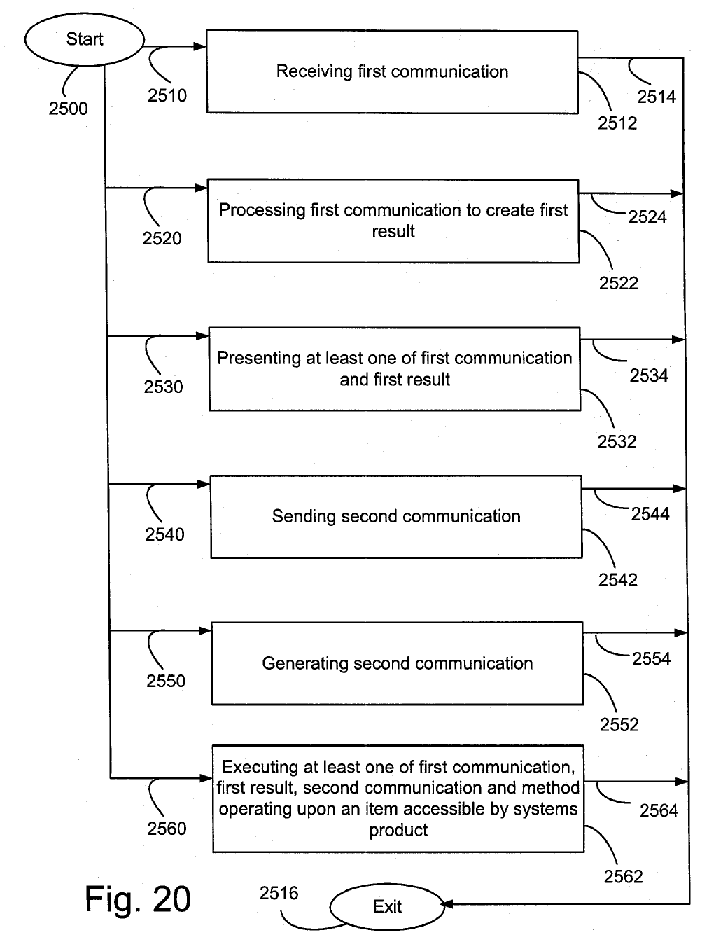

FIG. 20 illustrates a flowchart of systems product 5194 of FIG. 18 providing at least one of the operations of this Figure.

Operation 2512 performs receiving a first communication. Operation 2522 performs processing the first communication to create a first result. Operation 2532 performs presenting at least one member of the collection comprising the first communication and the first result. Operation 2542 performs sending a second communication. Operation 2552 performs generating the second communication. Operation 2562 performs executing at least one member of the collection comprising the first communication, the first result, the second communication and a method operating upon an item accessible by the systems product.

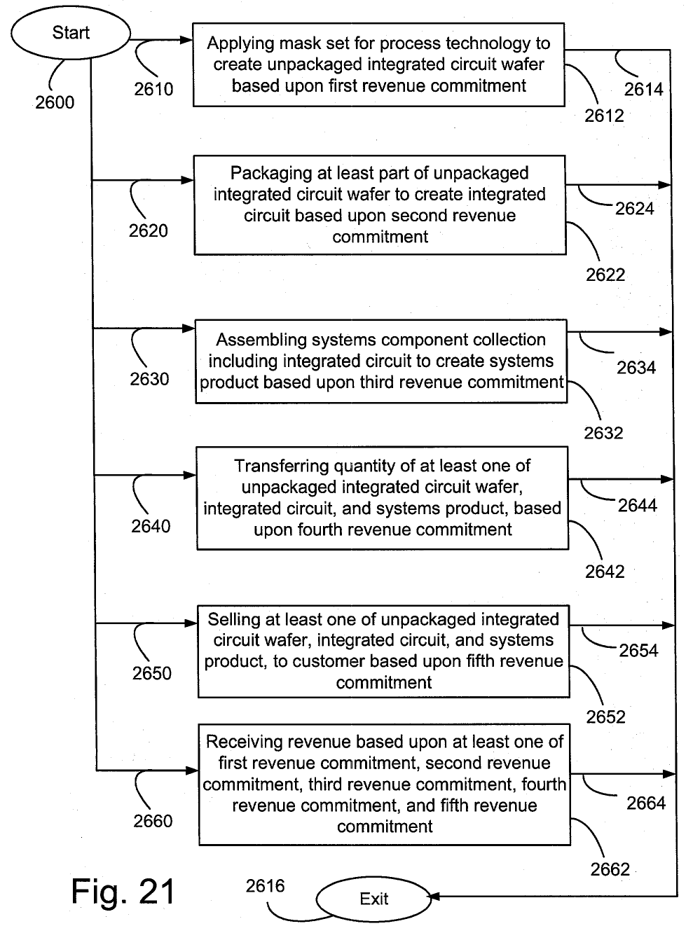

FIG. 21 illustrates a method of generating revenue based upon the mask set 5188 of FIGS. 18 and 19.

The method includes at least one of the following operations. Operation 2612 performs applying the mask set for a process technology to create an unpackaged integrated circuit wafer based upon a first revenue commitment. Operation 2622 performs packaging at least part of the unpackaged integrated circuit wafer to create an integrated circuit based upon a second revenue commitment. Operation 2632 performs assembling a systems component collection including the integrated circuit to create the systems product based upon a third revenue commitment. Operation 2642 performs transferring a quantity of at least one member of a collection comprising the unpackaged integrated circuit wafer, the integrated circuit, and the systems product, based upon a fourth revenue commitment. Operation 2652 performs selling at least one member of the collection comprising the unpackaged integrated circuit wafer, the integrated circuit, and the systems product, to a customer based upon a fifth revenue commitment.

The method of generating revenue further includes operation 2662. Operation 2662 performs receiving the revenue based upon at least one member of the revenue commitment collection comprising the first revenue commitment, the second revenue commitment, the third revenue commitment, the fourth revenue commitment, and the fifth revenue commitment.

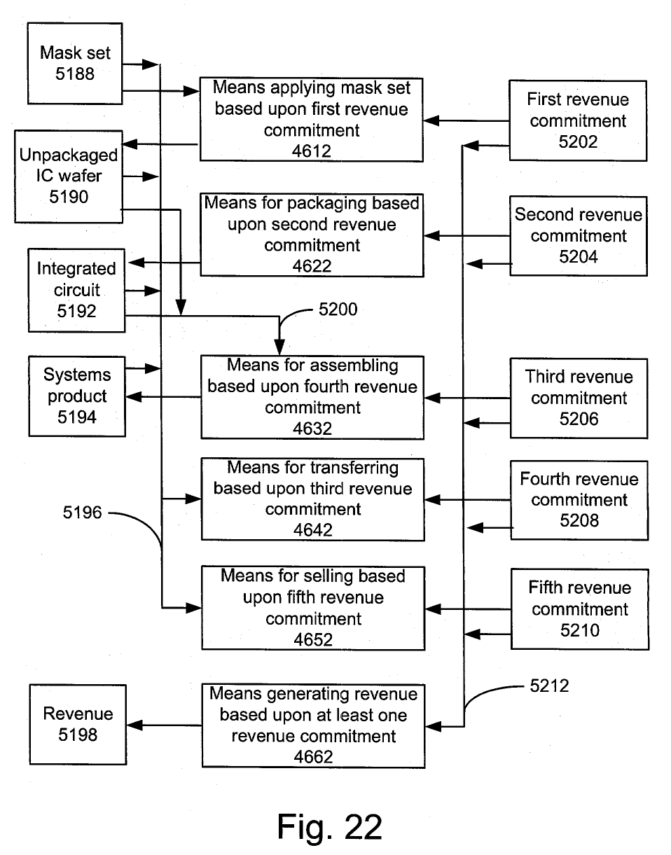

FIG. 22 illustrates a system implementing the method 2600 generating a revenue based upon the mask set of FIG. 21.

The system includes at least one of the following. Means 3612 for applying the mask set 5188 for a process technology to create an unpackaged integrated circuit wafer 5190 based upon a first revenue commitment 5202. Means 3622 for packaging at least part of the unpackaged integrated circuit wafer 5190 to create an integrated circuit 5192 based upon a second revenue commitment 5204. Means 3632 for assembling a systems component collection including the integrated circuit 5192 to create the systems product 5194 based upon a third revenue commitment 5206. Means 3642 for transferring a quantity of at least one of collection 5196 comprising the unpackaged integrated circuit wafer 5190, the integrated circuit 5192, and the systems product 5194, based upon a fourth revenue commitment 5208. Means 3652 for selling at least one member of collection 5196 to a customer based upon a fifth revenue commitment 5210.

The system also includes means 3662 for receiving the revenue 5198 based upon at least one member of the revenue commitment collection 5212 comprising the first revenue commitment 5202, the second revenue commitment 5204, the third revenue commitment 5206, the fourth revenue commitment 5208, and the fifth revenue commitment 5210.

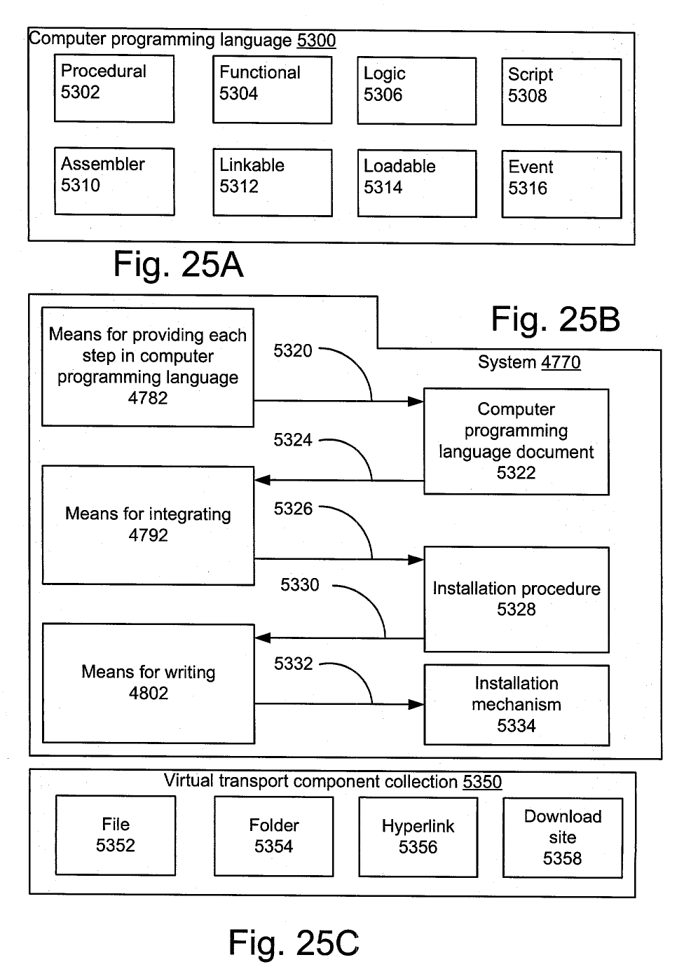

Note that the computer programming language collection is discussed with regards to FIG. 25A.

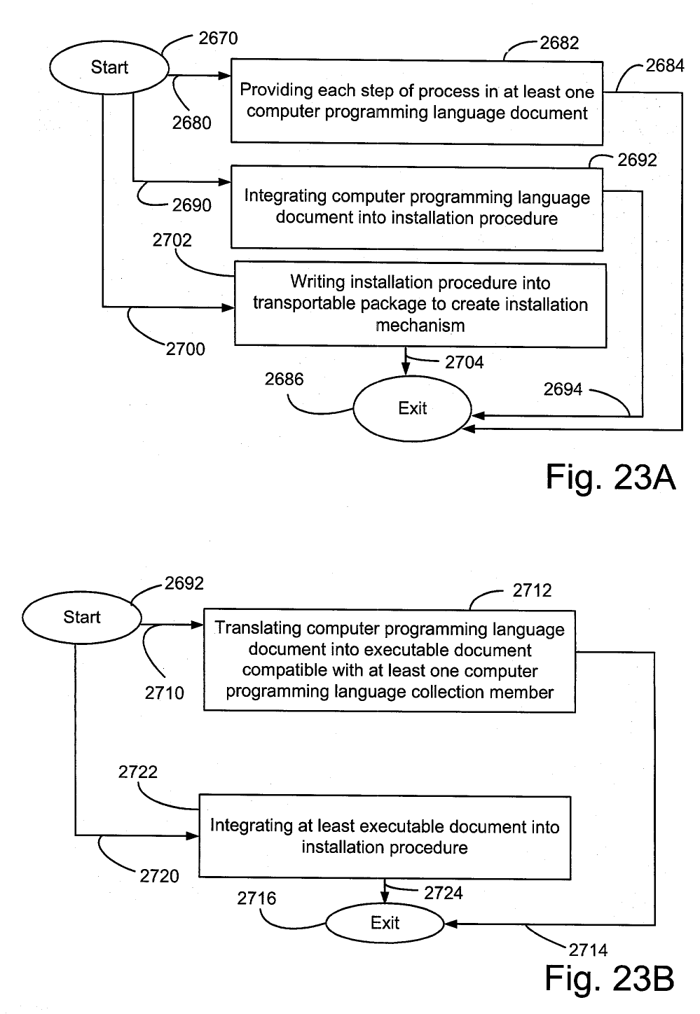

FIG. 23A illustrates a method 2670 making an installation mechanism for the process 1000 of FIG. 2A and the process 1200 of FIG. 5.

Operation 2682 performs providing each of the steps of the process in at least one computer programming language document compatible with a member of the computer programming language collection. Operation 2692 performs integrating the computer programming language document into an installation procedure. Operation 2702 performs writing the installation procedure into a transportable package to create the installation mechanism.

FIG. 23B illustrates a detail flowchart of operation 2692 of FIG. 23A further integrating the computer programming language document.

Operation 2712 performs translating the computer programming language document into an executable document compatible with at least one member of the computer programming language collection. Operation 2722 performs integrating at least the executable document into the installation procedure.

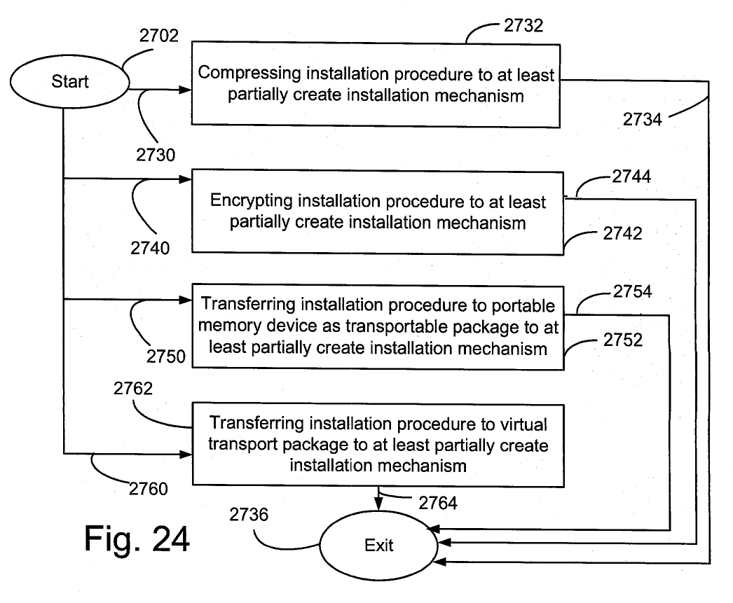

FIG. 24 illustrates a detail flowchart of operation 2702 of FIG. 23 further writing the installation procedure by at least one of the operations of this Figure.

Operation 2732 performs compressing the installation procedure to at least partially create the installation mechanism. Operation 2742 performs encrypting the installation procedure to at least partially create the installation mechanism. Operation 2752 performs transferring the installation procedure to a portable memory device as the transportable package to at least partially create the installation mechanism. Operation 2762 performs transferring the installation procedure to a virtual transport package discussed in FIG. 25C to at least partially create the installation mechanism.

FIG. 25A illustrates what is referred to by a computer programming language collection 5300.

As used herein, the computer programming language collection, includes to but is not limited to, procedural languages 5302, functional languages 5304, logic languages 5306, script languages 5308, assembly languages 5310, linkable languages 5312, loadable languages 5314 and event languages 5316. Procedural languages 5302 include but are not limited to FORTRAN, C, C++, Pascal, Java, Modula, and ADA. Functional languages 5304 include but are not limited to LISP and Scheme. Logic languages 5306 include Prolog and constraint based programming languages. Script languages 5308 include but are not limited to HTML, XML and Perl.

Assembler languages 5310 include but are not limited to assembly languages for actual instruction processors, for abstract instruction processors, for reconfigurable instruction processors, and for virtual instruction processors. As used herein, an actual instruction processor will execute an instruction format for at least one execution entity, which may include but is not limited to a processor engine and/or a datapath. A processor engine may control at least one member of the collection comprising at least one memory component, a messaging element and a finite state machine. Examples of actual instruction processors include but are not limited to microprocessors and digital signal processors.

Abstract instruction processors are often interpretive instruction processors, supporting an instruction set which is defined independently of a specific instruction processor. Examples of abstract instruction processors include, but are not limited to, the Java byte code abstract machine, the Warner abstract machine used as the intermediate language target of Prolog, the P-code intermediate language used as the compiler target for some implementations of Pascal, and the FORTH language kernel. Note that some of the abstract instruction processors support real-time integration of translated assembly instructions, providing for real-time extensible language environments.

Assembly languages for reconfigurable instruction processors often possess the ability to define the actions of at least some of the instructions as well as the instruction sequences used to control the execution of reconfigurable instruction processors.

Virtual instruction processors support virtual computing environments in which instruction actions occur across some communication fabric and involve a virtual real-time environment in which the number and capabilities of the instruction processing elements may vary over time, as well as the responsiveness to instructions and communications may also vary.

Linkable languages 5312 refer to formats often used as the target format for the assembly process translating assembly language documents. Linkable language documents are designed to be presented to a linkage editor to create at least one loadable language document. Loadable languages 5314 are referred to herein as hexadecimal loader format languages and binary loader format languages. Hexadecimal loader format languages represent addresses and data in a text format as hexadecimal and/or octal representations of data and addresses. A binary loader format language is the most commonly used format for rapid loading of executable documents. Operating systems almost universally support at least one binary loader format language. In many loadable languages, often a sequence of data addresses will be loaded by specifying the starting or ending address, the run length and then the successive data addresses. Many loadable languages additionally support the ability to load documents at varying actual addresses.

Event languages 5316 include but are not limited to event driven simulation languages such as Verilog and VHDL.

Some languages may be considered as members of more than one of the collections 5302-5316. LISP Scheme and FORTH, for instance, are extensible languages providing functional and/or procedural language capabilities, and which can incorporate their own language translators to assembler, linkable and/or loadable language formats.

FIG. 25B illustrates an apparatus implementing the method 2670 of FIG. 23A.

Means 3782 provides 5320 each of the steps of the process 1000 of FIG. 2A and/or process 1200 of FIG. 5 in at least one computer programming language document 5322 compatible with a member of a computer programming language collection 5300.

Means 3792 integrates 5324 the computer programming language document 5322 into 5326 an installation procedure 5328.

Means 3802 writes 5330 the installation procedure 5328 into a transportable package to create 5332 the installation mechanism 5334.

FIG. 25C illustrates the virtual transport component collection 5350 including files 5352, folders 5354, hyperlinks 5356 and download sites 5358.

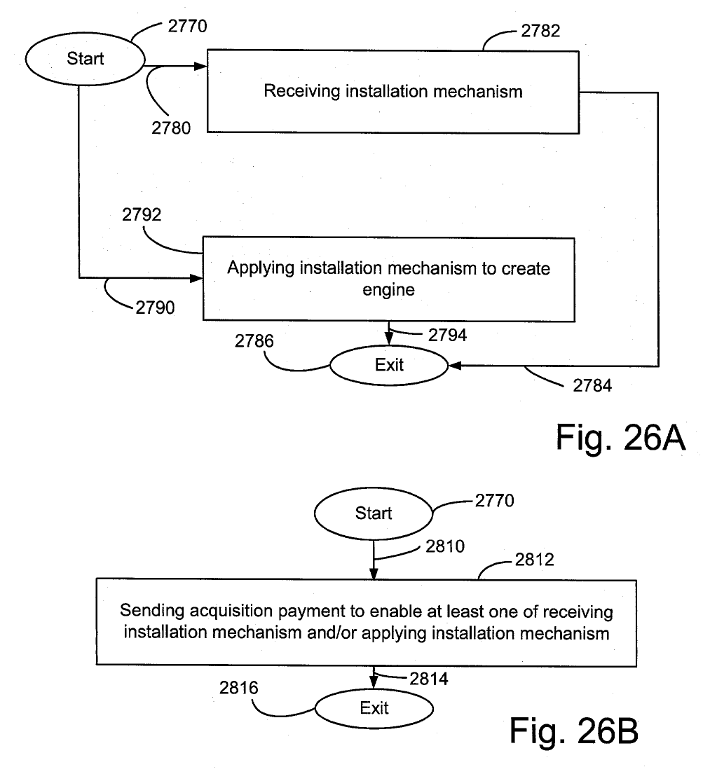

FIG. 26A illustrates a method 2770 of making engine 3000 of FIG. 4C and/or engine 3200 of FIG. 6 generating the synthesizable RECLN description 5020 emulating the ROM using the installation mechanism 5334.

Operation 2782 performs receiving the installation mechanism to create a local installation mechanism. Operation 2792 performs applying the installation mechanism 5334 to create the engine.

FIG. 26B illustrates a detail flowchart of method 2770 of FIG. 26A further making the engine.

Operation 2812 performs sending an acquisition payment to enable at least one of the operations of receiving 2782 and applying 2792 the installation mechanism 5334.

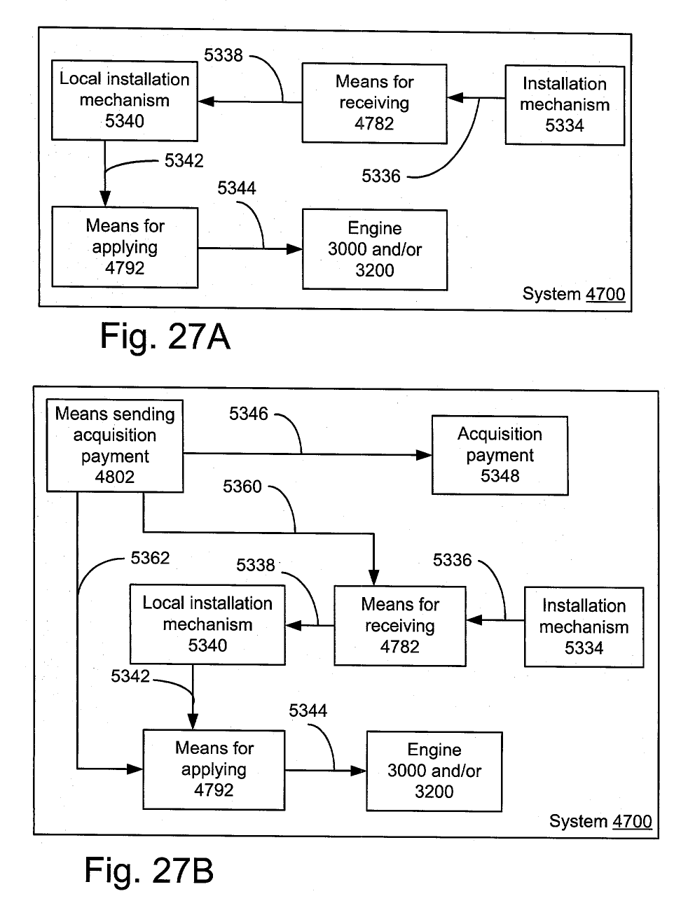

FIG. 27A illustrates a system making engines 3000 and/or 3200 by implementing the method 2770 of FIG. 26A.

FIG. 27B illustrates a system making engines 3000 and/or 3200 by implementing the method 2770 of FIGS. 26A and 26B.

Both FIGS. 27A and 27B including the following. Means 3782 receiving 5336 the installation mechanism 5334 to create 5338 a local installation mechanism 5340. Means 3792 applying 5342 the local installation mechanism 5340 to create 5344 the engine 3000 and/or 3200.

FIG. 27B further includes means 3802 sending 5346 an acquisition payment 5348 to enable 5360 receiving means 3782 and/or enable 5362 applying means 3792.

As used herein in FIGS. 26A-27B, receiving installation mechanism 5334 includes, but is not limited to, at least one member of the collection comprising receiving a portable memory device containing at least part of the installation mechanism, and receiving a virtual transport component containing at least part of the installation mechanism.

As used herein in FIGS. 26A-27B, applying the local installation mechanism 5340 to create the engine may include at least any combination of the following. Applying the local installation mechanism 5340 to at least one computer including an accessibly coupled memory to alter the memory to contain program steps implementing at least part of at least one of the steps of methods 1000 and/or 1200. Applying the local installation mechanism 5340 to the computer including a file management system to alter the file system to contain at least one file and/or one folder pointing to the program steps. Applying the local installation mechanism 5340 to the computer file management system configuration parameters to reference the contained file and/or folder pointing to the program steps. Applying the local installation mechanism 5340 to a finite state machine to alter its state transition table(s) and/or its actions at one or more of those states to implement at least part of one of the steps of the methods 1000 and 1200. Applying the local installation mechanism 5340 to an inferential logic engine to alter its inference rule and/or fact database to implement at least part of at least one step of the methods. Applying the local installation mechanism 5340 to a server to alter its allowable user action list and/or transaction processing list and/or web page list and/or hyperlinks.

As used herein, computer file management system configuration parameters include but are not limited to command paths, include paths for compilers, linkage editors, inferential systems, and database engines.

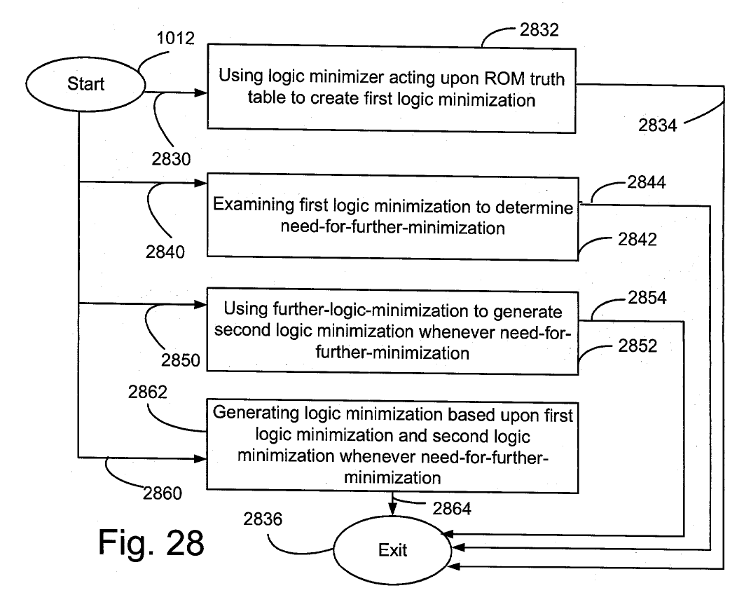

FIG. 28 illustrates a detail flowchart of operation 1012 of FIG. 2A further using the logic minimizer.

Operation 2832 performs using the logic minimizer acting upon the ROM truth table to create a first logic minimization. Operation 2842 performs examining the first logic minimization to a determine a need-for-further-minimization. Operation 2852 performs using further-logic-minimization to generate a second logic minimization whenever the need-for-further-minimization. Operation 2862 performs generating the logic minimization based upon the first logic minimization and based upon the second logic minimization whenever the need-for-further-minimization.

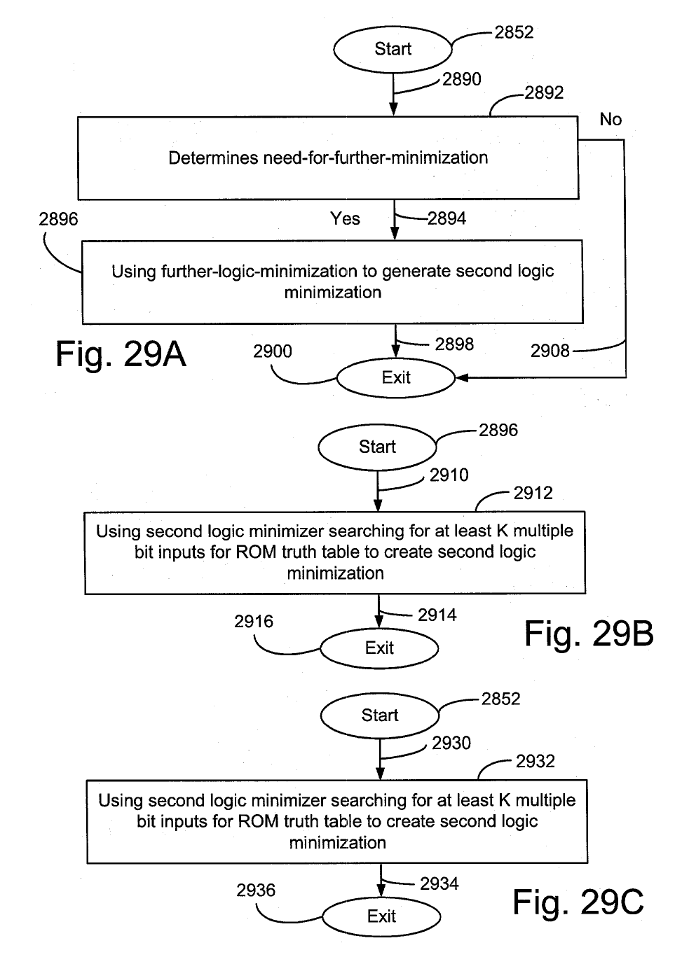

FIG. 29A illustrates a detail flowchart of operation 2852 of FIG. 28 further using further-logic-minimization to generate a second logic minimization whenever the need-for-further-minimization.

Operation 2892 determines the need-for-further-minimization. When the determination 2894 is ‘Yes’, operation 2896 performs using further-logic-minimization to generate a second logic minimization.

FIG. 29B illustrates a detail flowchart of operation 2896 of FIG. 29A further using further-logic-minimization to generate a second logic minimization.

Operation 2912 performs using a second logic minimizer searching for at least K multiple bit input for the ROM truth table to create the second logic minimization.

FIG. 29C illustrates a detail flowchart of operation 2852 of FIG. 28 further using further-logic-minimization.

Operation 2932 performs using a second logic minimizer searching for at least K multiple bit input for the ROM truth table to create the second logic minimization.

Note that in both FIGS. 29B and 29C, the K is at least one. Further, at least one of the multiple bit inputs includes at least L bit inputs of the ROM truth table, where L is at least two and may in certain situations, be preferably three and/or preferably four.

The first and second logic minimizers may be essentially the same, or distinct from each other. The logic minimizers may be derived from or implement a member of the logic minimization collection including at least Karnaugh maps, Veitch maps, Quine-McCluskey, mini, presto, and espresso algorithms.

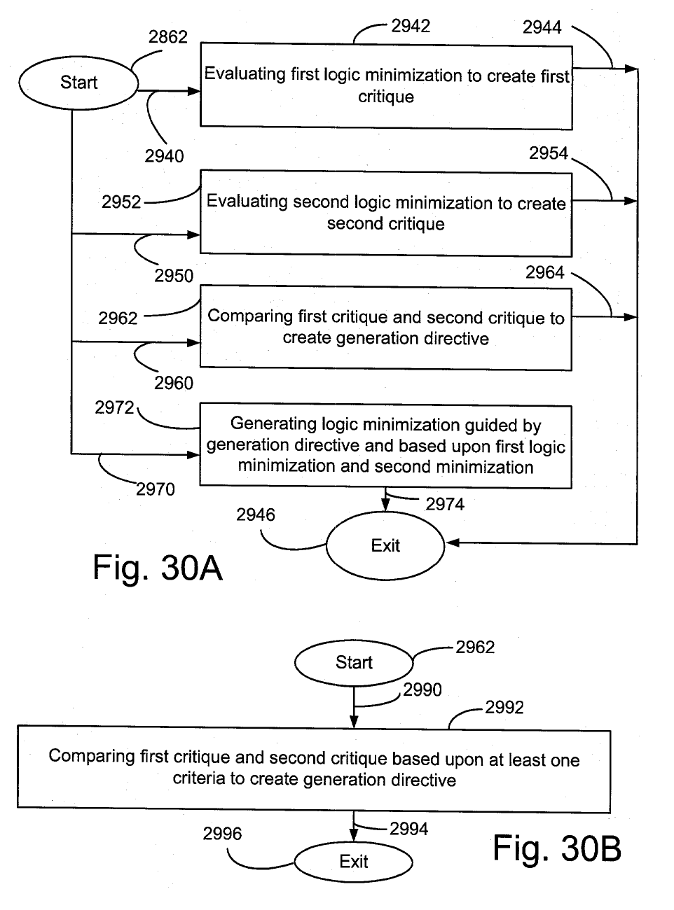

FIG. 30A illustrates a detail flowchart of operation 2862 of FIG. 28 further generating the logic minimization.

Operation 2942 performs evaluating the first logic minimization to create a first critique. Operation 2952 performs evaluating the second logic minimization to create a second critique. Operation 2962 performs comparing the first critique and the second critique to create a generation directive. Operation 2972 performs generating the logic minimization guided by the generation directive and based upon the first logic minimization and the second minimization.

FIG. 30B illustrates a detail flowchart of operation 2962 of FIG. 30A further comparing the first critique and the second critique.

Operation 2992 performs comparing the first critique and the second critique based upon at least one member of a criteria collection to create a generation directive.

The criteria collection includes at least a heat dissipation criteria, a propagation delay criteria, an area criteria, a logic complexity criteria, a layout criteria, and a target architecture compatibility criteria.

The preceding embodiments of the invention have been provided by way of example and are not meant to constrain the scope of the following claims.

In the claims:

1. A combinatorial logic network emulating a ROM receiving N address input signals, fetching from a table based upon said N address input signals a collection of M data signals, comprising:
for each of said M data signals, an output generator circuit receiving an generator input collection and generating said data signal, wherein said output generator network for said data signal consists essentially of:
a first combinatorial logic network receiving said generator input collection and generating said data signal;
wherein said generator input collection is comprised of at least one member of an internal signal collection;
wherein said N is at least six;
wherein said M is at least one;
wherein said internal signal collection is comprised of at least said N address input signals;
wherein each of said output signal generators generates a member of the collection comprising:
said data signal as one of said generator input collection members;
said data signal as a negation of said one generator input collection member;
said data signal as a logic product function of at least two of said generator input collection members;
said data signal as a negation of said logical product function of at least two of said generator input collection members;
said data signal as a logic sum function of at least two of said generator input collection members;
said data signal as a negation of said logic sum function of at least two of said generator input collection members;
said data signal as an exclusive-or function of said generator input collection members;
said data signal as a negation of said exclusive-or function of said generator input collection members;
said data signal as a multiplexing function of at least part of said generator input collection, said multiplexing function controlled by at least one by said generator input collection members; and
said data signal as a logic function of at least one intermediate signal generated by an instance of a member of a combinatorial logic function collection, each of said instances generating said intermediate signal as said combinatorial logic function member of at least part of said generator input collection members;
wherein said combinatorial logic function collection is comprised of:
one of said generator input collection members;
a negation of said one generator input collection member;
said data signal as a logic product function of at least two of said generator input collection members;
said data signal as a negation of said logical product function of at least two of said generator input collection members;
said data signal as a logic sum function of at least two of said generator input collection members;
said data signal as a negation of said logic sum function of at least two of said generator input collection members;
said data signal as an exclusive-or function of said generator input collection members;
said data signal as a negation of said exclusive-or function of said generator input collection members; and
said data signal as a multiplexing function of at least part of said generator input collection, said multiplexing function controlled by at least one by said generator input collection members.

2. The apparatus of claim 1, further comprising:
a shared signal generator collection comprising at least one shared signal generator receiving at least one member of said internal signal collection to create a shared generator input collection and generating a shared signal;
wherein each of said shared signal generators consists essentially of a second combinatorial logic network receiving said shared generator input collection to generate said shared signal; and
wherein said internal signal collection is further comprised of all of said shared signals;
wherein each of said first combinatorial logic networks is implemented as a member of the collection comprising: at least part of a gate array; a standard cell network; a custom logic cell network; at least part of a programmable logic array network; and at least part of a logic cell array network;
wherein for at least one of said shared signal collection members, a first of said output generator collection members includes said shared signal collection member in said first combinatorial logic network and a second of said output generator collection members includes said shared signal collection member in said first combinatorial logic network.

3. The apparatus of claim 2,
wherein at least one of said shared signal generators generates a member of the collection comprising:
said shared signal as a logic product function of said shared generator input collection members;
said shared signal as a negation of said logical product function of said shared generator input collection members;
said shared signal as a logic sum function of said shared generator input collection members;
said shared signal as a negation of said logic sum function of said shared generator input collection members;
said shared signal as an exclusive-or function of said shared generator input collection members; and
said shared signal as a negation of said exclusive-or function of said shared generator input collection members.

4. The apparatus of claim 2,
wherein at least a first of said shared generator input collections includes at least one of said members generated by a second of said shared signal generators.

5. The apparatus of claim 1,
wherein at least one said second combinatorial logic networks is implemented as a member of the collection comprising: at least part of a gate array; a standard cell network; a custom logic cell network; at least part of a programmable logic array; and at least part of a logic cell array.

6. The apparatus of claim 1, further comprising:
a propagation delay output generator receiving at least one input signaling start of propagation and generating output-ready for said generated data signals.

7. A circuit, comprising:
an engine coupled by said address input signals and by said data signals to said RECLN of claim 1;
wherein said engine provides said address input signals to said RECLN; and
wherein said RECLN generates said data signals based upon said provided address input signals.

8. A method doing a business based upon generating a synthesizable RECLN description emulating a ROM, comprising the steps of:
ordering a ROM synthesis order including an order payment mechanism;
receiving said ROM input communication based upon said ROM synthesis order from said first user to create said ROM truth table;
using a logic minimizer acting upon a ROM truth table to create a logic minimization;
converting said logic minimization into said synthesizable RECLN description emulating said ROM;
sending said synthesizable RECLN description to a second user based upon said ROM synthesis order; and
receiving at least one service payment based upon said order payment mechanism;
wherein the step converting said logic minimization into said synthesizable RECLN description, is further comprised of the steps of:
converting said logic minimization into a first RECLN description; and
verifying said first RECLN description emulating said ROM to create said synthesizable RECLN description.

9. The method of claim 8,
wherein the step verifying said first RECLN description, is further comprised of at least one member of the collection comprising the steps of:
verifying said first RECLN description emulating said ROM based upon said ROM truth table to create said synthesizable RECLN description;
verifying said first RECLN description emulating said ROM based upon said ROM input communication to create said synthesizable RECLN description; and
verifying said first RECLN description emulating said ROM based upon a ROM vector set generated from said ROM input communication to create said synthesizable RECLN description.

10. The method of claim 8,
wherein the step verifying said first RECLN description, is further comprised of the step of:
generating a second RECLN description based upon said logic minimization; and
wherein the step verifying said first RECLN description is further comprised of at least one member of the collection comprising the steps of:
simulating said ROM based upon said ROM truth table using said second RECLN description to create said synthesizable RECLN description;
simulating said ROM based upon said ROM input communication using said second RECLN description to create said synthesizable RECLN description; and
simulating said ROM based upon said ROM vector set generated from at least one member of the collection comprising said ROM truth table and said ROM input communication, using said second RECLN description to create said synthesizable RECLN description.

11. The method of claim 8,
wherein the step receiving said ROM input communication is comprised of at least one member of the collection comprising the steps of:
receiving said ROM truth table;
receiving a ROM pattern communication; and
receiving a ROM vector communication;
wherein the step receiving said ROM pattern communication is further comprised of the steps of:
receiving a ROM pattern; and
translating said ROM pattern into said ROM truth table; and
wherein the step receiving said ROM vector communication is further comprised of the steps of:
receiving a ROM vector set; and
translating said ROM vector set into said ROM truth table;
wherein said ROM pattern is backward compatible with a memory loader format belonging to a load format collection comprising a hex loader format and a binary loader format; and
wherein said ROM vector set is backward compatible with a logic simulator vector format belonging to a hexadecimal vector format and a bit vector format and a binary vector format.

12. The method of claim 8,
wherein a communication collection is comprised of said ROM input communication and said synthesizable RECLN description;
wherein each member of said communications collection includes at least one document;
wherein the step receiving said ROM input communication from said first user is further comprised of at least one member of the collection comprising the steps of:
receiving a first file containing a version of said ROM input communication document;
receiving a first portable memory device containing said version of said ROM input communication document;
receiving a first wireless data transfer containing said version of said ROM input communication document;
receiving a message from said first user containing at least one member of the collection comprising said version of said ROM input communication document and a first link; and
accessing said first link to receive said version of said ROM input communication document;
wherein the step sending said synthesizable RECLN description to said second user is further comprised of at least one member of the collection comprising the steps of:
sending a second file containing a version of said synthesizable RECLN description document;
sending a second portable memory device containing said version of said synthesizable RECLN description document;
sending a second wireless data transfer containing said version of said synthesizable RECLN description document;
sending a message to said second user containing at least one member of the collection comprising said version of said synthesizable RECLN description document and a second link; and
accessing said second link to receive said version of said synthesizable RECLN description document;
wherein said version of said document of said communications collection member involves at least one member of a version collection comprising a binary version of said document, a text editor version of said document, a compressed version of said document, an executable version providing said document, and an encrypted version of said document;
wherein each of said first and second portable memory devices belongs to a portable memory collection comprising a bar-coded device, a non-volatile semiconductor memory device, a non-volatile electromagnetic memory device, a non-volatile optical memory device, and a battery powered portable memory device;
wherein said battery includes at least one member of the collection comprising a rechargeable battery, a limited charge battery, and a fuel cell.

13. The method of claim 8,
wherein a user collection is comprised of said first user and said second user;
wherein at least one of said user collection members includes at least one member of the collection comprising a human being, a computer, a network address, an authentication code, and a software agent residing upon a finite state machine.

14. The method of claim 8,
wherein said synthesizable RECLN description includes at least two documents.

15. The method of claim 8,
wherein at least one of said synthesizable RECLN description documents is compatible with a form of at least one member of a simulation language collection comprising at least VHDL, Verilog, C, C++, matlab, and Java.

16. The method of claim 8, wherein said first user is said second user.

17. The method of claim 8,
wherein an organization employs at least one member of the collection comprising said first user and said second user and a third user;
wherein the step ordering said ROM synthesis order is further comprised of at least one member of the collection comprising the steps of:
said first user ordering said ROM synthesis order;
said organization ordering said ROM synthesis order;
said second user ordering said ROM synthesis order; and
said third user ordering said ROM synthesis order;
wherein said organization is a member of the collection comprising a human individual operating for profit, a sole proprietorship, a corporation, a partnership, a government, a non-profit organization performing work for hire, said first user, said second user, and said third user.

18. Said service payment as a product of the process of claim 8.

19. The method of claim 8,
wherein said ROM synthesis order involves a subscription providing a service generating said synthesizable RECLN descriptions.

20. The method of claim 8,
wherein the step ordering said ROM synthesis order is further comprised at least one member of the collection comprising the steps of:
ordering by a request-for-quote to create said ROM synthesis order;
ordering by an offer-acceptance to create said ROM synthesis order; and
ordering by an offer-counteroffer-acceptance to create said ROM synthesis order;
wherein the step ordering by said request-for-quote is further comprised of the steps of:
receiving a request for an offer for said ROM synthesis order;
sending an offer for said ROM synthesis order including a payment offer; and
receiving an acceptance of said offer for said ROM synthesis order to create said ROM synthesis order including an order payment mechanism based upon said payment offer;
wherein the step ordering by said offer-acceptance is futher comprised of the steps of:
receiving an offer for said ROM synthesis order including a payment offer; and
sending an acceptance of said offer for said ROM synthesis order to create said ROM synthesis order including said order payment mechanism based upon said payment offer;
wherein the step ordering by said offer-counteroffer-acceptance is further comprised of the steps of:
receiving an offer for said ROM synthesis order including a payment offer;
sending a counter-offer based upon said offer including a payment counter-offer; and
receiving an acceptance of said counter-offer to create said ROM synthesis order including said order payment mechanism based upon said payment counter-offer.

21. The method of claim 20,
wherein said ROM synthesis order includes at least one member of the collection comprising an address range, a word size, and a delivery time condition as part of said payment mechanism.

22. The method of claim 20,
wherein at least one member of a receiving collection comprising the steps receiving a request for an offer, receiving said offer for said ROM synthesis order, and receiving said acceptance, is further comprised of at least one member of the collection comprising of the steps of:
a first service computer performing said receiving collection member;
a first fax machine performing said receiving collection member; and
receiving a first paper to perform said receiving collection member;
wherein at least one member of a sending collection sending comprising the steps of said offer, sending said acceptance, and sending said counter-offer, is further comprised of at least one member of the collection comprising the steps of:
a second service computer performing said sending collection member;
a second fax machine performing said sending collection member; and
sending a second paper to perform said sending collection member.

23. The method of claim 20,
wherein said payment mechanism is comprised of at least one member of the payment mechanism collection including a prepayment mechanism, a receipt payment mechanism for said ROM input communication, a delivery payment mechanism for said synthesizable RECLN description, a post-delivery payment mechanism, an escrow account payment mechanism, and a subscription payment mechanism;
wherein said payment offer is further comprised a first of at least two alternative payment mechanisms and a second of said alternative payment mechanisms;
wherein each of said alternative payment mechanism includes at least one member of said payment mechanism collection; and
wherein said acceptance of said payment offer is comprised of acceptance of one of said alternative payment mechanisms to create an accepted alternative payment mechanism;
wherein at least one member of the payment mechanism collection includes at least one member of a payment type collection including a monetary payment and a stock payment;
wherein said monetary payment is in terms of a currency; and
wherein said stock payment is in terms of a stock transaction offer.

24. The method of claim 8,
wherein the step using said logic minimizer is comprised of at least one member of the collection comprising the steps of:
using a third computer running a logic minimizer computer program generating said logic minimization based upon said ROM truth table;
using a first server maintaining a logic minimizer web site generating said logic minimization based upon said ROM truth table; and
using a logic minimizer engine presented said ROM truth table to create said logic minimization; and
wherein the step converting said logic minimization is comprised of at least one member of the collection comprising the steps of:
using a fourth computer running a logic converter computer program converting said logic minimization into said synthesizable RECLN description emulating said ROM based upon said ROM truth table;
using a second server maintaining a logic converter web site converting said logic minimization into said synthesizable RECLN description emulating said ROM based upon said ROM truth table; and
using a logic converter engine presented said logic minimization to create said synthesizable RECLN description emulating said ROM based upon said ROM truth table;
wherein said logic minimizer engine is related to said logic converter engine by at least one member of the collection comprising:
said logic minimizer engine and said logic converter engine belong to a logic engine; and
said logic minimizer engine is communicatively coupled to said logic converter engine;
wherein said third computer is related to said fourth computer by a member of the collection comprising:
said third computer is essentially said fourth computer; and
said third computer is distinct from said fourth computer;
wherein said first server is related to said second server by a member of the collection comprising:
said first server is essentially said second server; and
said first server is distinct from said second server.

25. The method of claim 8,
wherein the step using said logic minimizer is further comprised of the steps of:
using said logic minimizer acting upon said ROM truth table to create a first logic minimization;
examining said first logic minimization to a determine a need-for-further-minimization;
performing further-logic-minimization to generate a second logic minimization whenever said need-for-further-minimization; and
generating said logic minimization based upon said first logic minimization and based upon said second logic minimization whenever said need-for-further-minimization.

26. The method of claim 25,
wherein the step performing further-logic-minimization is further comprised of the step of:
using a second logic minimizer searching for at least K multiple bit input for said ROM truth table to create said second logic minimization; and
wherein said K is a member of the collection comprising one and two;
wherein at least one said multiple bit inputs includes at least L bit inputs of said ROM truth table;
wherein L is a member of the collection comprising two, three and four;
wherein said first logic minimizer is related to said second logic minimizer by a member of the collection comprising:
said first logic minimizer is essentially said second logic minimizer;
said first logic minimizer and said second logic minimizer are versions of espresso; and
said first logic minimizer is distinct from said second logic minimizer.

27. The method of claim 25,
wherein the step generating said logic minimization is further comprised of the steps of:
evaluating said first logic minimization to create a first critique;
evaluating said second logic minimization to create a second critique;
comparing said first critique and said second critique to create a generation directive; and
generating said logic minimization guided by said generation directive and based upon said first logic minimization and said second minimization;
wherein the step comparing said first critique and said second critique is further comprised of the steps of:
comparing said first critique and said second critique based upon at least one member of a criteria collection to create a generation directive;
wherein said criteria collection is comprised of a heat dissipation criteria, a propagation delay criteria, an area criteria, a logic complexity criteria, a layout criteria, and a target architecture compatibility criteria.

28. Said synthesizable RECLN description as a product of the process of claim 8.

29. A method generating a netlist based upon a circuit description incorporating said synthesizable RECLN description of claim 8, comprising the steps of:
integrating said synthesizable RECLN description into a preliminary circuit description to create said circuit description; and
extracting said netlist from said circuit description.

30. The method of claim 29,
wherein the step integrating said synthesizable RECLN description is further comprised of the steps of:
integrating said synthesizable RECLN description into said preliminary circuit description to create a synthesizable circuit description; and
synthesizing said synthesizable circuit description to create said circuit description.

31. Each member of the collection comprising said netlist and said circuit description as a product of the process of claim 29.

32. A method of generating at least one member of the collection comprising a circuit layout, a mask set, an unpackaged integrated circuit wafer, an integrated circuit, and a systems product, comprising at least one member of the collection comprising the steps of:
compiling said netlist of claim 29 with at least one cell layout library to create said circuit layout;
generating a mask set based upon at least said circuit layout;
applying said mask set for a process technology to create said unpackaged integrated circuit wafer;
packaging at least part said unpackaged integrated circuit wafer to create said integrated circuit; and
assembling a systems component collection including said integrated circuit to create said systems product.

33. Each member of said collection comprising member comprising said circuit layout, said mask set, said unpackaged integrated circuit wafer, said integrated circuit, and said systems product, as products of the process of claim 32.

34. The method of claim 32,
wherein said systems product provides at least one member of the operations collection comprised of the steps of:
receiving a first communication;
processing said first communication to create a first result;
presenting at least one member of the collection comprising said first communication and said first result;
sending a second communication;
generating said second communication; and
executing at least one member of the collection comprising said first communication, said first result, said second communication and a method operating upon an item accessible by said systems product.

35. A method of generating a revenue based upon said mask set of claim 32, comprising at least one member of the collection comprising the steps of:
applying said mask set for a process technology to create an unpackaged integrated circuit wafer based upon a first revenue commitment;
packaging at least part of said unpackaged integrated circuit wafer to create an integrated circuit based upon a second revenue commitment;
assembling a systems component collection including said integrated circuit to create said systems product based upon a third revenue commitment;
transferring a quantity of at least one member of a collection comprising said unpackaged integrated circuit wafer, said integrated circuit, and said systems product, based upon a fourth revenue commitment; and
selling at least one member of the collection comprising said unpackaged integrated circuit wafer, said integrated circuit, and said systems product, to a customer based upon a fifth revenue commitment; and said method is further comprised of the step of:
receiving said revenue based upon at least one member of the revenue commitment collection comprising said first revenue commitment, said second revenue commitment, said third revenue commitment, said fourth revenue commitment, and said fifth revenue commitment.

36. Said revenue as a product of the process of claim 35.

37. A method making an installation mechanism for the process of claim 8, comprising the steps of:
providing each of said steps of said process in at least one computer programming language document compatible with a member of a computer programming language collection;
integrating said computer programming language document into an installation procedure; and
writing said installation procedure into a transportable package to create said installation mechanism;
wherein said computer language collection is comprised of the members of at least a procedural language collection, a functional language collection, a logic language collection, a script language collection, an assembler language collection, a linkable language collection, a loadable language collection and an event language collection.

38. Said installation mechanism as a product of the process of claim 37.

39. The method of claim 37,
wherein the step integrating said computer programming language document is further comprised of the steps of:
translating said computer programming language document into an executable document compatible with at least one member of said computer programming language collection; and
integrating at least said executable document into said installation procedure.

40. The method of claim 37,
wherein the step writing said installation procedure is comprised of at least one member of the collection comprising the steps of:
compressing said installation procedure to at least partially create said installation mechanism;
encrypting said installation procedure to at least partially create said installation mechanism;
transferring said installation procedure to a portable memory device as said transportable package to at least partially create said installation mechanism; and
transferring said installation procedure to a virtual transport package to at least partially create said installation mechanism;
wherein said virtual transport package includes at least one member of a virtual transport component collection comprising a file, a folder, a hyperlink, and a download site;
wherein said portable memory device belongs to a portable memory collection comprising a bar-coded device, a non-volatile semiconductor memory device, a non-volatile electro-magnetic memory device, a non-volatile optical memory device, and a battery powered portable memory device;
wherein said battery includes at least one member of the collection comprising a rechargeable battery, a limited charge battery, and a fuel cell.

41. A method of making an engine generating said synthesizable RECLN description emulating said ROM using said installation mechanism of claim 37, comprising the steps of:
receiving said installation mechanism to create a local installation mechanism; and
applying said local installation mechanism to create said engine.

42. The method of claim 41,
wherein the step receiving said installation mechanism is further comprised of the step of:
sending an acquisition payment to enable at least one member of a collection comprising the steps of: receiving and applying of said local installation mechanism.

43. Said acquisition payment as a product of the process of claim 42.

44. Each member of the collection comprising said local installation mechanism and said engine as a product of the process of claim 41.

45. A program system comprising program steps residing in a memory accessibly coupled to a computer, wherein said computer acting upon said program steps implements the steps of the method of claim 8.

46. An apparatus implementing the method of claim 8, comprising, for each step of said method, a means for implementing said step.

47. The apparatus of claim 46,
wherein for at least one of said means, said means is comprised of at least one of the collection comprising:
a computer accessibly coupled to a memory containing a program step of a program system implementing at least said step of said means,
a finite state machine implementing said step of said means,
a neural network with a trained response approximating said step of said means, and
an inferential engine containing a rule set implementing said step of said means;
wherein said computer includes at least one instruction processor controlling at least one data path;
wherein said finite state machine includes at least one member of a FSM element collection comprising altering a finite state of said finite state machine; wherein said FSM element collection is comprised of a fixed logic network, reconfigurable logic network, an FSM memory, a programmable logic network including at least one programmable logic element;
wherein said programmable logic element is comprised of at least one member of the collection comprising a programmable logic array, a programmable logic device, and a field programmable gate array.

48. The apparatus implementing of said method of claim 8, comprising:
a computer accessibly coupled to a memory and controlled by a program system comprising program steps implementing the steps of said method;
wherein said program steps reside in at least one memory accessibly coupled to said computer; and
wherein said computer includes at least one instruction processor controlling at least one data path.

49. A method generating a synthesizable synchronous RECLN description emulating a synchronous ROM including a synchronous address port coupled to a ROM coupled to a synchronous data output port, comprising the steps of:
using the method of claim 8 to create a synthesizable RECLN description emulating said ROM;
generating said synthesizable synchronous RECLN description as a synthesizable synchronous address port coupled to an address port of said synthesizable RECLN description, and a data port of said synthesizable RECLN description coupled to a synthesizable synchronous data port.

50. A method emulating a ROM receiving N address input signals, fetching from a table based upon said N address input signals a collection of M data signals, comprising for each of said M data signals, the steps of:
receiving an generator input collection; and
generating said data signal as a first combinatorial logic function of said generator input collection members;
wherein for each of said M data signals, said generator input collection is comprised of at least one member of an internal signal collection;
wherein said N is at least six;
wherein said M is at least one;
wherein said internal signal collection is comprised of at least said N address input signals;
wherein the step generating at least one of said output signals a member of the collection comprising the steps of:
generating said data signal as one of said generator input collection members;
generating said data signal as a negation of said one generator input collection member;
generating said data signal as a logic product function of at least two of said generator input collection members;
generating said data signal as a negation of said logical product function of at least two of said generator input collection members;
generating said data signal as a logic sum function of at least two of said generator input collection members;
generating said data signal as a negation of said logic sum function of at least two of said generator input collection members;
generating said data signal as an exclusive-or function of said generator input collection members;
generating said data signal as a negation of said exclusive-or function of said generator input collection members;
generating said data signal as a multiplexing function of at least part of said generator input collection, said multiplexing function controlled by at least one by said generator input collection members;
generating said data signal as a negation of said multiplexing function of at least part of said generator input collection, said multiplexing function controlled by at least one by said generator input collection members; and
generating said data signal as a logic function of at least one intermediate signal generated by an instance of a member of a combinatorial logic function collection, each of said instances generating said intermediate signal as said combinatorial logic function member of at least part of said generator input collection members;
wherein said combinatorial logic function collection is comprised of:
one of said generator input collection members;
a negation of said one generator input collection member;
said data signal as a logic product function of at least two of said generator input collection members;
said data signal as a negation of said logical product function of at least two of said generator input collection members;
said data signal as a logic sum function of at least two of said generator input collection members;
said data signal as a negation of said logic sum function of at least two of said generator input collection members;
said data signal as an exclusive-or function of said generator input collection members;
said data signal as a negation of said exclusive-or function of said generator input collection members;
said data signal as a multiplexing function of at least part of said generator input collection, said multiplexing function controlled by at least one by said generator input collection members; and
said data signal as a negation of said multiplexing function of at least part of said generator input collection, said multiplexing function controlled by at least one by said generator input collection members.

51. The method of claim 50, further comprising the steps of:
receiving at least one member of said internal signal collection to create a shared generator input collection; and
generating a shared signal as a second combinatorial logic function of said shared generator input collection;
wherein said internal signal collection is further comprised of all of said shared signals.

52. The method of claim 51,
wherein at least one member of the collection of the steps generating said shared signals is comprised of a member of the collection comprising the steps of:
generating said shared signal as a logic product function of said shared generator input collection members;
generating said shared signal as a negation of said logical product function of said shared generator input collection members;
generating said shared signal as a logic sum function of said shared generator input collection members;
generating said shared signal as a negation of said logic sum function of said shared generator input collection members;
generating said shared signal as an exclusive-or function of said shared generator input collection members; and
generating said shared signal as a negation of said exclusive-or function of said shared generator input collection members.

53. The method of claim 51,
wherein at least a first of said shared generator input collections includes at least one of said members generated by a second of said steps generating said shared signals.

54. The method of claim 50,
wherein at least one said second combinatorial logic functions is implemented as a member of the collection comprising: at least part of a gate array; a standard cell network; a custom logic cell network; at least part of a programmable logic array; and at least part of a logic cell array.

55. The method of claim 50, further comprising the step:
generating a propagation delay output receiving at least one input signaling start of propagation and generating output-ready for said generated data signals.

56. A method replacing an engine coupled by said address input signals and by said data signals to said ROM, comprising the steps of:
operating said engine to provide said address input signals;
the steps of claim 50 receiving said address input signals and generating said data signals; and
operating said engine based upon said generated data signals.

57. A method generating a synthesizable RECLN description emulating a ROM, comprising the steps of:
using a logic minimizer acting upon a ROM truth table to create a logic minimization; and
converting said logic minimization into said synthesizable RECLN description emulating said ROM.

58. The method of claim 57, further comprising the step of:
receiving a ROM input communication to create said ROM truth table.

59. The method of claim 58,
wherein the step converting said logic minimization into said synthesizable RECLN description, is further comprised of the steps of:
converting said logic minimization into a first RECLN description; and
verifying said first RECLN description emulating said ROM to create said synthesizable RECLN description.

60. The method of claim 59,
wherein the step verifying said first RECLN description, is further comprised of at least one member of the collection comprising the steps of:
verifying said first RECLN description emulating said ROM based upon said ROM truth table to create said synthesizable RECLN description;
verifying said first RECLN description emulating said ROM based upon said ROM input communication to create said synthesizable RECLN description; and
verifying said first RECLN description emulating said ROM based upon a ROM vector set generated from said ROM input communication to create said synthesizable RECLN description.

61. The method of claim 59,
wherein the step verifying said first RECLN description, is further comprised of the step of:
generating a second RECLN description based upon said logic minimization; and
wherein the step verifying said first RECLN description is further comprised of at least one member of the collection comprising the steps of:
simulating said ROM based upon said ROM truth table using said second RECLN description to create said synthesizable RECLN description;
simulating said ROM based upon said ROM input communication using said second RECLN description to create said synthesizable RECLN description; and
simulating said ROM based upon said ROM vector set generated from at least one member of the collection comprising said ROM truth table and said ROM input communication, using said second RECLN description to create said synthesizable RECLN description.

62. The method of claim 58,
wherein the step receiving said ROM input communication is comprised of at least one member of the collection comprising the steps of:
receiving said ROM truth table;
receiving a ROM pattern communication; and
receiving a ROM vector communication;
wherein the step receiving said ROM pattern communication is further comprised of the steps of:
receiving a ROM pattern; and
translating said ROM pattern into said ROM truth table; and
wherein the step receiving said ROM vector communication is further comprised of the steps of:
receiving a ROM vector set; and
translating said ROM vector set into said ROM truth table;
wherein said ROM pattern is backward compatible with a memory loader format belonging to a load format collection comprising a hex loader format and a binary loader format; and
wherein said ROM vector set is backward compatible with a logic simulator vector format belonging to a hexadecimal vector format and a bit vector format and a binary vector format.

63. The method of claim 58,
wherein the step receiving said ROM input communication is further comprised of the step of:
receiving said ROM input communication from a first user to create said ROM truth table; and
wherein said method is further comprised of the step of:
sending said synthesizable RECLN description to a second user.

64. The method of claim 63,
wherein a communication collection is comprised of said ROM input communication and said synthesizable RECLN description;
wherein each member of said communications collection includes at least one document;
wherein the step receiving said ROM input communication from said first user is further comprised of at least one member of the collection comprising the steps of:
receiving a first file containing a version of said ROM input communication document;
receiving a first portable memory device containing said version of said ROM input communication document;
receiving a first wireless data transfer containing said version of said ROM input communication document;
receiving a message from said first user containing at least one member of the collection comprising said version of said ROM input communication document and a first link; and
accessing said first link to receive said version of said ROM input communication document;
wherein the step sending said synthesizable RECLN description to said second user is further comprised of at least one member of the collection comprising the steps of:
sending a second file containing a version of said synthesizable RECLN description document;
sending a second portable memory device containing said version of said synthesizable RECLN description document;
sending a second wireless data transfer containing said version of said synthesizable RECLN description document;
sending a message to said second user containing at least one member of the collection comprising said version of said synthesizable RECLN description document and a second link; and
accessing said second link to receive said version of said synthesizable RECLN description document;
wherein said version of said document of said communications collection member involves at least one member of a version collection comprising a binary version of said document, a text editor version of said document, a compressed version of said document, an executable version providing said document, and an encrypted version of said document;
wherein each of said first and second portable memory devices belongs to a portable memory collection comprising a bar-coded device, a non-volatile semiconductor memory device, a non-volatile electromagnetic memory device, a non-volatile optical memory device, and a battery powered portable memory device;
wherein said battery includes at least one member of the collection comprising a rechargeable battery, a limited charge battery, and a fuel cell.

65. The method of claim 63,
wherein a user collection is comprised of said first user and said second user;
wherein at least one of said user collection members includes at least one member of the collection comprising a human being, a computer, a network address, an authentication code, and a software agent residing upon a finite state machine.

66. The method of claim 63,
wherein said synthesizable RECLN description includes at least two documents.

67. The method of claim 63,
wherein at least one of said synthesizable RECLN description documents is compatible with a form of at least one member of a simulation language collection comprising at least VHDL, Verilog, C, C++, matlab, and Java.

68. The method of claim 63, wherein said first user is said second user.

69. The method of claim 63, further comprising at least the first member of the collection comprising the steps of:
ordering a ROM synthesis order including an order payment mechanism; and
receiving at least one service payment based upon said order payment mechanism.

70. The method of claim 69,
wherein an organization employs at least one member of the collection comprising said first user and said second user and a third user;
wherein the step ordering said ROM synthesis order is further comprised of at least one member of the collection comprising the steps of:
said first user ordering said ROM synthesis order;
said organization ordering said ROM synthesis order;
said second user ordering said ROM synthesis order; and
said third user ordering said ROM synthesis order;
wherein said organization is a member of the collection comprising a human individual operating for profit, a sole proprietorship, a corporation, a partnership, a government, a non-profit organization performing work for hire, said first user, said second user, and said third user.

71. Said service payment as a product of the process of claim 69.

72. The method of claim 69,
wherein said ROM synthesis order involves a subscription providing a service generating said synthesizable RECLN descriptions.

73. The method of claim 69,
wherein the step receiving said ROM input communication is further comprised of the step of:
receiving said ROM input communication based upon said ROM synthesis order from said first user to create said ROM truth table.

74. The method of claim 69,
wherein the step sending said synthesizable RECLN description is further comprised of the step of:
sending said synthesizable RECLN description to said second user based upon said ROM synthesis order.

75. The method of claim 69,
wherein the step ordering said ROM synthesis order is further comprised at least one member of the collection comprising the steps of:
ordering by a request-for-quote to create said ROM synthesis order;
ordering by an offer-acceptance to create said ROM synthesis order; and
ordering by an offer-counteroffer-acceptance to create said ROM synthesis order;
wherein the step ordering by said request-for-quote is further comprised of the steps of:
receiving a request for an offer for said ROM synthesis order;
sending an offer for said ROM synthesis order including a payment offer; and
receiving an acceptance of said offer for said ROM synthesis order to create said ROM synthesis order including an order payment mechanism based upon said payment offer;
wherein the step ordering by said offer-acceptance is further comprised of the steps of:
receiving an offer for said ROM synthesis order including a payment offer; and
sending an acceptance of said offer for said ROM synthesis order to create said ROM synthesis order including said order payment mechanism based upon said payment offer;
wherein the step ordering by said offer-counteroffer-acceptance is further comprised of the steps of:
receiving an offer for said ROM synthesis order including a payment offer;
sending a counter-offer based upon said offer including a payment counter-offer; and
receiving an acceptance of said counter-offer to create said ROM synthesis order including said order payment mechanism based upon said payment counter-offer.

76. The method of claim 75,
wherein said ROM synthesis order includes at least one member of the collection comprising an address range, a word size, and a delivery time condition as part of said payment mechanism.

77. The method of claim 75,
wherein at least one member of a receiving collection comprising the steps receiving a request for an offer, receiving said offer for said ROM synthesis order, and receiving said acceptance, is further comprised of at least one member of the collection comprising of the steps of:
a first service computer performing said receiving collection member;
a first fax machine performing said receiving collection member; and
receiving a first paper to perform said receiving collection member;
wherein at least one member of a sending collection sending comprising the steps of said offer, sending said acceptance, and sending said counter-offer, is further comprised of at least one member of the collection comprising the steps of:
a second service computer performing said sending collection member;
a second fax machine performing said sending collection member; and
sending a second paper to perform said sending collection member.

78. The method of claim 75,
wherein said payment mechanism is comprised of at least one member of the payment mechanism collection including a prepayment mechanism, a receipt payment mechanism for said ROM input communication, a delivery payment mechanism for said synthesizable RECLN description, a post-delivery payment mechanism, an escrow account payment mechanism, and a subscription payment mechanism;
wherein said payment offer is further comprised a first of at least two alternative payment mechanisms and a second of said alternative payment mechanisms;
wherein each of said alternative payment mechanism includes at least one member of said payment mechanism collection; and
wherein said acceptance of said payment offer is comprised of acceptance of one of said alternative payment mechanisms to create an accepted alternative payment mechanism;
wherein at least one member of the payment mechanism collection includes at least one member of a payment type collection including a monetary payment and a stock payment;
wherein said monetary payment is in terms of a currency; and
wherein said stock payment is in terms of a stock transaction offer.

79. The method of claim 57,
wherein the step using said logic minimizer is comprised of at least one member of the collection comprising the steps of:
using a third computer running a logic minimizer computer program generating said logic minimization based upon said ROM truth table;
using a first server maintaining a logic minimizer web site generating said logic minimization based upon said ROM truth table; and
using a logic minimizer engine presented said ROM truth table to create said logic minimization; and
wherein the step converting said logic minimization is comprised of at least one member of the collection comprising the steps of:
using a fourth computer running a logic converter computer program converting said logic minimization into said synthesizable RECLN description emulating said ROM based upon said ROM truth table;
using a second server maintaining a logic converter web site converting said logic minimization into said synthesizable RECLN description emulating said ROM based upon said ROM truth table; and
using a logic converter engine presented said logic minimization to create said synthesizable RECLN description emulating said ROM based upon said ROM truth table;
wherein said logic minimizer engine is related to said logic converter engine by at least one member of the collection comprising:
said logic minimizer engine and said logic converter engine belong to a logic engine; and
said logic minimizer engine is communicatively coupled to said logic converter engine;
wherein said third computer is related to said fourth computer by a member of the collection comprising:
said third computer is essentially said fourth computer; and
said third computer is distinct from said fourth computer;
wherein said first server is related to said second server by a member of the collection comprising:
said first server is essentially said second server; and
said first server is distinct from said second server.

80. The method of claim 57,
wherein the step using said logic minimizer is farther comprised of the steps of:
using said logic minimizer acting upon said ROM truth table to create a first logic minimization;
examining said first logic minimization to a determine a need-for-further-minimization;
using further-logic-minimization to generate a second logic minimization whenever said need-for-further-minimization; and
generating said logic minimization based upon said first logic minimization and based upon said second logic minimization whenever said need-for-further-minimization.

81. The method of claim 80,
wherein the step using further-logic-minimization is further comprised of the step of:
using a second logic minimizer searching for at least K multiple bit inputs for said ROM truth table to create said second logic minimization; and
wherein said K is a member of the collection comprising one and two;
wherein at least one of said multiple bit inputs includes at least L bit inputs of said ROM truth table;
wherein L is a member of the collection comprising two, three and four;
wherein said first logic minimizer is related to said second logic minimizer by a member of the collection comprising:
said first logic minimizer is essentially said second logic minimizer; and
said first logic minimizer is distinct from said second logic minimizer.

82. The method of claim 80,
wherein the step generating said logic minimization is further comprised of the steps of:
evaluating said first logic minimization to create a first critique;
evaluating said second logic minimization to create a second critique;
comparing said first critique and said second critique to create a generation directive; and
generating said logic minimization guided by said generation directive and based upon said first logic minimization and said second minimization;
wherein the step comparing said first critique and said second critique is further comprised of the steps of:
comparing said first critique and said second critique based upon at least one member of a criteria collection to create a generation directive;
wherein said criteria collection is comprised of a heat dissipation criteria, a propagation delay criteria, an area criteria, a logic complexity criteria, a layout criteria, and a target architecture compatibility criteria.

83. Said synthesizable RECLN description as a product of the process of claim 57.

84. A method generating a netlist based upon a circuit description incorporating said synthesizable RECLN description of claim 57, comprising the steps of:
integrating said synthesizable RECLN description into a preliminary circuit description to create said circuit description; and
extracting said netlist from said circuit description.

85. The method of claim 84,
wherein the step integrating said synthesizable RECLN description is further comprised of the steps of:
integrating said synthesizable RECLN description into said preliminary circuit description to create a synthesizable circuit description; and
synthesizing said synthesizable circuit description to create said circuit description.

86. Each member of the collection comprising said netlist and said circuit description as a product of the process of claim 84.

87. A method of generating at least one member of the collection comprising a circuit layout, a mask set, an unpackaged integrated circuit wafer, an integrated circuit, and a systems product, comprising at least one member of the collection comprising the steps of:
compiling said netlist of claim 84 with at least one cell layout library to create said circuit layout;
generating a mask set based upon at least said circuit layout;
applying said mask set for a process technology to create said unpackaged integrated circuit wafer;
packaging at least part of said unpackaged integrated circuit wafer to create said integrated circuit; and
assembling a systems component collection including said integrated circuit to create said systems product.

88. Each member of said collection comprising member comprising said circuit layout, said mask set, said unpackaged integrated circuit wafer, said integrated circuit, and said systems product, as products of the process of claim 87.

89. The method of claim 87,
wherein said systems product provides at least one member of the operations collection comprised of the steps of:
receiving a first communication;
processing said first communication to create a first result;
presenting at least one member of the collection comprising said first communication and said first result;
sending a second communication;
generating said second communication; and
executing at least one member of the collection comprising said first communication, said first result, said second communication and a method operating upon an item accessible by said systems product.

90. A method of generating a revenue based upon said mask set of claim 87, comprising at least one member of the collection comprising the steps of:
applying said mask set for a process technology to create an unpackaged integrated circuit wafer based upon a first revenue commitment;
packaging at least part of said unpackaged integrated circuit wafer to create an integrated circuit based upon a second revenue commitment;
assembling a systems component collection including said integrated circuit to create said systems product based upon a third revenue commitment;
transferring a quantity of at least one member of a collection comprising said unpackaged integrated circuit wafer, said integrated circuit, and said systems product, based upon a fourth revenue commitment; and
selling at least one member of the collection comprising said unpackaged integrated circuit wafer, said integrated circuit, and said systems product, to a customer based upon a fifth revenue commitment; and said method is further comprised of the step of:
receiving said revenue based upon at least one member of the revenue commitment collection comprising said first revenue commitment, said second revenue commitment, said third revenue commitment, said fourth revenue commitment, and said fifth revenue commitment.

91. Said revenue as a product of the process of claim 90.

92. A method making an installation mechanism for the process of claim 57, comprising the steps of:
providing each of said steps of said process in at least one computer programming language document compatible with a member of a computer programming language collection;
integrating said computer programming language document into an installation procedure; and
writing said installation procedure into a transportable package to create said installation mechanism;
wherein said computer programming language collection is comprised of the members of at least a procedural language collection, a functional language collection, a logic language collection, a script language collection, an assembler language collection, a linkable language collection, a loadable language collection and an event language collection.

93. Said installation mechanism as a product of the process of claim 92.

94. The method of claim 92,
wherein the step integrating said computer programming language document is further comprised of the steps of:
translating said computer programming language document into an executable document compatible with at least one member of said computer programming language collection; and
integrating at least said executable document into said installation procedure.

95. The method of claim 92,
wherein the step writing said installation procedure is comprised of at least one member of the collection comprising the steps of:
compressing said installation procedure to at least partially create said installation mechanism;
encrypting said installation procedure to at least partially create said installation mechanism;
transferring said installation procedure to a portable memory device as said transportable package to at least partially create said installation mechanism; and
transferring said installation procedure to a virtual transport package to at least partially create said installation mechanism;
wherein said virtual transport package includes at least one member of a virtual transport component collection comprising a file, a folder, a hyperlink, and a download site;
wherein said portable memory device belongs to a portable memory collection comprising a bar-coded device, a non-volatile semiconductor memory device, a non-volatile electro-magnetic memory device, a non-volatile optical memory device, and a battery powered portable memory device;
wherein said battery includes at least one member of the collection comprising a rechargeable battery, a limited charge battery, and a fuel cell.

96. A method of making an engine generating said synthesizable RECLN description emulating said ROM using said installation mechanism of claim 92, comprising the steps of:
receiving said installation mechanism to create a local installation mechanism; and
applying said local installation mechanism to create said engine.

97. The method of claim 96,
wherein the step receiving said installation mechanism is further comprised of the step of:
sending an acquisition payment to enable at least one member of a collection comprising the steps of: receiving and applying of said local installation mechanism.

98. Said acquisition payment as a product of the process of claim 97.

99. Each member of the collection comprising said local installation mechanism and said engine as a product of the process of claim 96.

100. A program system comprising program steps residing in a memory accessibly coupled to a computer, wherein said computer acting upon said program steps implements the steps of the method of claim 57.

101. The method of claim 57,
wherein the step converting said logic minimization into said synthesizable RECLN description, is further comprised of the steps of:
converting said logic minimization into a first RECLN description; and
verifying said first RECLN description emulating said ROM to create said synthesizable RECLN description.

102. The method of claim 101,
wherein the step verifying said first RECLN description, is further comprised of at least one member of the collection comprising the steps of:
verifying said first RECLN description emulating said ROM based upon said ROM truth table to create said synthesizable RECLN description; and
verifying said first RECLN description emulating said ROM based upon a ROM vector set generated from said ROM truth table to create said synthesizable RECLN description.

103. The method of claim 101,
wherein the step verifying said first RECLN description, is further comprised of the steps of:
generating a second RECLN description based upon said logic minimization;
simulating said ROM based upon said ROM truth table using said second RECLN description to create said synthesizable RECLN description.

104. An apparatus implementing the method of claim 57, comprising, for each step of said method, a means for implementing said step.

105. The apparatus of claim 104,
wherein for at least one of said means, said means is comprised of at least one of the collection comprising:
a computer accessibly coupled to a memory containing a program step of a program system implementing at least said step of said means,
a finite state machine implementing said step of said means,
a neural network with a trained response approximating said step of said means, and
an inferential engine containing a rule set implementing said step of said means;
wherein said computer includes at least one instruction processor controlling at least one data path;
wherein said finite state machine includes at least one member of a FSM element collection comprising altering a finite state of said finite state machine; wherein said FSM element collection is comprised of a fixed logic network, reconfigurable logic network, an FSM memory, a programmable logic network including at least one programmable logic element;
wherein said programmable logic element is comprised of at least one member of the collection comprising a programmable logic array, a programmable logic device, and a field programmable gate array.

106. The apparatus implementing of said method of claim 57, comprising:
a computer accessibly coupled to a memory and controlled by a program system comprising program steps implementing the steps of said method;
wherein said program steps reside in at least one memory accessibly coupled to said computer; and
wherein said computer includes at least one instruction processor controlling at least one data path.

107. A method generating a synthesizable synchronous RECLN description emulating a synchronous ROM including a synchronous address port coupled to a ROM coupled to a synchronous data output port, comprising the steps of:
using the method of claim 57 to create a synthesizable RECLN description emulating said ROM;
generating said synthesizable synchronous RECLN description as a synthesizable synchronous address port coupled to an address port of said synthesizable RECLN description, and a data port of said synthesizable RECLN description coupled to a synthesizable synchronous data port.

108. A method emulating a ROM receiving N address input signals, fetching from a table based upon said N address input signals a collection of M data signals, comprising for each of said M data signals, the steps of:
receiving an generator input collection; and
generating said data signal as a first combinatorial logic function of said generator input collection members;
wherein for each of said M data signals, said generator input collection is comprised of at least one member of an internal signal collection;
wherein said N is at least two;
wherein said M is at least one;
wherein said internal signal collection is comprised of at least said N address input signals.

109. The method of claim 108, further comprising the steps of:
receiving at least one member of said internal signal collection to create a shared generator input collection; and
generating a shared signal as a second combinatorial logic function of said shared generator input collection;
wherein said internal signal collection is further comprised of all of said shared signals.

110. The method of claim 109,
wherein at least one member of the collection of the steps generating said shared signals is comprised of a member of the collection comprising the steps of:
generating said shared signal as a logic product function of said shared generator input collection members;
generating said shared signal as a negation of said logical product function of said shared generator input collection members;
generating said shared signal as a logic sum function of said shared generator input collection members;
generating said shared signal as a negation of said logic sum function of said shared generator input collection members;
generating said shared signal as an exclusive-or function of said shared generator input collection members; and
generating said shared signal as a negation of said exclusive-or function of said shared generator input collection members.

111. The method of claim 109,
wherein at least a first of said shared generator input collections includes at least one of said members generated by a second of said steps generating said shared signals.

112. The method of claim 108,
wherein at least one said second combinatorial logic functions is implemented as a member of the collection comprising: at least part of a gate array; a standard cell network; a custom logic cell network; at least part of a programmable logic array; and at least part of a logic cell array.

113. The method of claim 108,
wherein said N is at least a member of the collection comprising three, four, five, and six.

114. The method of claim 108,
wherein the step generating at least one of said output signals a member of the collection comprising the steps of:
generating said data signal as one of said generator input collection members;
generating said data signal as a negation of said one generator input collection member;
generating said data signal as a logic product function of at least two of said generator input collection members;
generating said data signal as a negation of said logical product function of at least two of said generator input collection members;
generating said data signal as a logic sum function of at least two of said generator input collection members;
generating said data signal as a negation of said logic sum function of at least two of said generator input collection members;
generating said data signal as an exclusive-or function of said generator input collection members;
generating said data signal as a negation of said exclusive-or function of said generator input collection members;
generating said data signal as a multiplexing function of at least part of said generator input collection, said multiplexing function controlled by at least one by said generator input collection members;
generating said data signal as a negation of said multiplexing function of at least part of said generator input collection, said multiplexing function controlled by at least one by said generator input collection members; and
generating said data signal as a logic function of at least one intermediate signal generated by an instance of a member of a combinatorial logic function collection, each of said instances generating said intermediate signal as said combinatorial logic function member of at least part of said generator input collection members;
wherein said combinatorial logic function collection is comprised of:
one of said generator input collection members;
a negation of said one generator input collection member;
said data signal as a logic product function of at least two of said generator input collection members;
said data signal as a negation of said logical product function of at least two of said generator input collection members;
said data signal as a logic sum function of at least two of said generator input collection members;
said data signal as a negation of said logic sum function of at least two of said generator input collection members;
said data signal as an exclusive-or function of said generator input collection members;
said data signal as a negation of said exclusive-or function of said generator input collection members;
said data signal as a multiplexing function of at least part of said generator input collection, said multiplexing function controlled by at least one by said generator input collection members; and
said data signal as a negation of said multiplexing function of at least part of said generator input collection, said multiplexing function controlled by at least one by said generator input collection members.

115. The method of claim 108, further comprising the step:
generating a propagation delay output receiving at least one input signaling start of propagation and generating output-ready for said generated data signals.

116. A method replacing an engine coupled by said address input signals and by said data signals to said ROM, comprising the steps of:
operating said engine to provide said address input signals;
the steps of claim 108 receiving said address input signals and generating said data signals; and
operating said engine based upon said generated data signals.

117. A combinatorial logic network emulating a ROM receiving N address input signals, fetching from a table based upon said N address input signals a collection of M data signals, comprising:
for each of said M data signals, an output generator circuit receiving an generator input collection and generating said data signal, wherein said output generator network for said data signal consists essentially of:
a first combinatorial logic network receiving said generator input collection and generating said data signal;
wherein said generator input collection is comprised of at least one member of an internal signal collection;
wherein said N is at least two;
wherein said M is at least one;
wherein said internal signal collection is comprised of at least said N address input signals.

118. The apparatus of claim 117, further comprising:
a shared signal generator collection comprising at least one shared signal generator receiving at least one member of said internal signal collection to create a shared generator input collection and generating a shared signal;
wherein each of said shared signal generators consists essentially of a second combinatorial logic network receiving said shared generator input collection to generate said shared signal; and
wherein said internal signal collection is further comprised of all of said shared signals;
wherein for at least one of said shared signal collection members, a first of said output generator collection members includes said shared signal collection member in said first combinatorial logic network and a second of said output generator collection members includes said shared signal collection member in said first combinatorial logic network.

119. The apparatus of claim 118,
wherein at least one of said shared signal generators generates a member of the collection comprising:
said shared signal as a logic product function of said shared generator input collection members;
said shared signal as a negation of said logical product function of said shared generator input collection members;
said shared signal as a logic sum function of said shared generator input collection members;
said shared signal as a negation of said logic sum function of said shared generator input collection members;
said shared signal as an exclusive-or function of said shared generator input collection members; and
said shared signal as a negation of said exclusive-or function of said shared generator input collection members.

120. The apparatus of claim 118,
wherein at least a first of said shared generator input collections includes at least one of said members generated by a second of said shared signal generators.

121. The apparatus of claim 117,
wherein at least one said second combinatorial logic networks is implemented as a member of the collection comprising: at least part of a gate array; a standard cell network; a custom logic cell network; at least part of a programmable logic array; and at least part of a logic cell array.

122. The apparatus of claim 117,
wherein said N is at least a member of the collection comprising three, four, five, six, seven, and eight.

123. The apparatus of claim 117,
wherein at least one of said output signal generators generates a member of the collection comprising:
said data signal as one of said generator input collection members;
said data signal as a negation of said one generator input collection member;
said data signal as a logic product function of at least two of said generator input collection members;
said data signal as a negation of said logical product function of at least two of said generator input collection members;
said data signal as a logic sum function of at least two of said generator input collection members;
said data signal as a negation of said logic sum function of at least two of said generator input collection members;
said data signal as an exclusive-or function of said generator input collection members;
said data signal as a negation of said exclusive-or function of said generator input collection members;
said data signal as a multiplexing function of at least part of said generator input collection, said multiplexing function controlled by at least one by said generator input collection members;
said data signal as a negation of said multiplexing function of at least part of said generator input collection, said multiplexing function controlled by at least one by said generator input collection members; and
said data signal as a logic function of at least one intermediate signal generated by an instance of a member of a combinatorial logic function collection, each of said instances generating said intermediate signal as said combinatorial logic function member of at least part of said generator input collection members;
wherein said combinatorial logic function collection is comprised of:
one of said generator input collection members;
a negation of said one generator input collection member;
said data signal as a logic product function of at least two of said generator input collection members;
said data signal as a negation of said logical product function of at least two of said generator input collection members;
said data signal as a logic sum function of at least two of said generator input collection members;
said data signal as a negation of said logic sum function of at least two of said generator input collection members;
said data signal as an exclusive-or function of said generator input collection members;
said data signal as a negation of said exclusive-or function of said generator input collection members;
said data signal as a multiplexing function of at least part of said generator input collection, said multiplexing function controlled by at least one by said generator input collection members; and
said data signal as a negation of said multiplexing function of at least part of said generator input collection, said multiplexing function controlled by at least one by said generator input collection members.

124. The apparatus of claim 117,
wherein at least one said first combinatorial logic networks is implemented as a member of the collection comprising: at least part of a gate array; a standard cell network; a custom logic cell network; at least part of a programmable logic array network; and at least part of a logic cell array network.

125. The apparatus of claim 117, further comprising:
a propagation delay output generator receiving at least one input signaling start of propagation and generating output-ready for said generated data signals.

126. A circuit, comprising:
an engine coupled by said address input signals and by said data signals to said RECLN of claim 117;
wherein said engine provides said address input signals to said RECLN; and
wherein said RECLN generates said data signals based upon said provided address input signals.
